(19) United States
(12) Patent Application Publication
(10) Pub. No.: US 2011/0180210 A1
(43) Pub. Date: Jul. 28, 2011

(54) PRESSURE BONDING APPARATUS AND METHOD

(76) Inventors: Kazuo Mori, Yamanashi (JP); Chihiro Igarashi, Yamanashi (JP)

(21) Appl. No.: 13/121,762

(22) PCT Filed: Sep. 29, 2009
(86) PCT No.: PCT/JP2009/004982

§ 371 Date: Mar. 30, 2011

(30) Foreign Application Priority Data
Sep. 30, 2008 (JP) 2008-253615
Sep. 30, 2008 (JP) 2008-253646

(51) Int. Cl. B32B 37/18

(52) U.S. Cl. 156/297

(57) ABSTRACT

To provide a pressure bonding apparatus comprising a plurality of pressure bonding units comprising pressing members including pressing surfaces for pressing objects against pressure bonding areas on edge portions of a substrate and edge portion support members for supporting the edge portions of the substrate, the plurality of pressure bonding units arranged in a row along a first direction, a protection sheet supplying device for supplying along the first direction a protection sheet that has a width more than at least twice a width of the pressing surfaces of the pressing members in a second direction orthogonal to the first direction and that protects the pressing surfaces by being interposed between the pressing surfaces of the pressing members and the objects and for suspending the protection sheet under tension along the first direction between the plurality of pressing members and the edge portion support members, and a second direction sheet moving device for moving the protection sheet in a range not smaller than the width of the pressing surfaces of the pressing members in the second direction and changing contact positions of the pressing members on the protection sheet in the second direction.

### TECHNICAL FIELD

The present invention relates to a pressure bonding apparatus and method for pressing and pressure bonding objects by pressing surfaces of pressing members of pressure bonding units and particularly to a pressure bonding apparatus and method for pressing and pressure bonding joining sheets for joining components to pressure bonding areas on edge portions of a substrate typified by a liquid crystal glass panel substrate, a plasma display panel substrate and the like.

### BACKGROUND ART

Conventionally, display devices have been produced by pressure bonding and mounting of components such as electronic components, mechanical components, and optical components, substrates such as flexible printed circuit boards (FPC boards), semiconductor package components such as COG (Chip On Glass), COF (Chip On Film), IC chips, and TCP (Tape Carrier Package) and/or the like on substrates (which will be referred to as “panel substrates”) such as liquid crystal display (LCD) panel substrates and plasma display panel (PDP) substrates.

A component mounting apparatus (component mounting line) for such panel substrates (e.g., liquid crystal display substrates) has an ACF applying apparatus for performing an ACF applying process of applying anisotropic conductive sheets (ACF sheets) on terminal portions (pressure bonding areas) formed on edge portions on one side or two sides of a panel substrate held by a component holding device, a component temporary pressure-bonding apparatus for performing a component temporary pressure bonding process of temporarily pressure bonding components such as TCP through medium of the ACF sheets onto the terminal portions by pressure bonding units, a final pressure-bonding apparatus for performing a final pressure bonding process of pressure bonding and mounting the components, temporarily press-bonded onto the terminal portions, through medium of the ACF sheets while pressing and heating by a pressure and a temperature higher than those in the temporary pressure-bonding, and a substrate conveyor apparatus for holding the panel substrate from a lower face side thereof and sequentially conveying the panel substrate so that the panel substrate can be worked in the apparatuses. In a conventional component mounting line having such a configuration, the panel substrate is subjected to the specified processes in the apparatuses while being sequentially conveyed by the substrate conveyor apparatus, so that the components are mounted on the terminal portions of the panel substrate.

When a thermal pressure bonding tool of the pressure bonding unit is lowered onto a component placed (temporarily press-bonded) on a terminal portion of a panel substrate through an ACF sheet, so as to press and bond the components, in the final pressure-bonding apparatus of such a component mounting apparatus, a portion of the ACF sheet is prone to adhere onto a bottom surface (pressing surface) of the thermal press-boding tool. There is an issue in that the adhesion of the ACF sheet to the thermal boding tool makes an obstacle to subsequent final pressure bonding processes. A similar problem occurs in the ACF applying apparatus and the component temporary pressure-bonding apparatus that may cause adhesion of a portion of the ACF sheet to a thermal boding head.

Therefore, conventional final pressure-bonding apparatuses employ a method in which a protection sheet (tool protection sheet) for preventing contamination is placed between the thermal pressure bonding tool and a panel substrate so as to prevent an ACF sheet from adhering onto the bottom surface of the thermal boding tool and in which a component is press-bonded by being pressed by the bottom surface of the thermal boding tool through the protection sheet, and the like (see Patent Literature 1, for instance). Since the ACF adheres onto the protection sheet, a fresh protection sheet having no contamination can be supplied to between the thermal boding tool and a panel substrate by sequential feeding the sheet from a supply reel to a winding reel.
Patent Document 1: JP H08-184847 A

### DISCLOSURE OF INVENTION

### Problems to be Solved by the Invention

In recent years, increase in sizes and number of items of panel substrates that are handled in such conventional component mounting lines has been becoming more remarkable with increase in sizes and number of items of display devices such as monitors. This has caused severe demands from markets for reduction in product cost and strong demands for efficient production.

In conventional final pressure-bonding apparatuses and the like, therefore, a plurality of thermal pressure bonding units arranged in a row are provided, and thermal pressure bonding of a plurality of components placed on terminal portions of a panel substrate is simultaneously performed by the plurality of thermal pressure bonding units, so that reduction in time required for the final pressure bonding operation and increase in production efficiency are attained.

Provided that a final pressure bonding operation is performed by the plurality of thermal pressure bonding units through a protection sheet supplied and placed along a longitudinal direction of the terminal portions of the panel substrate, for instance, with the increase in sizes and number of items of panel substrates, however, it is necessary to forward and wind the protection sheet contaminated by the adhesion of the ACF thereto and to forward a fresh protection sheet, after the operation, in order to prepare for the subsequent final pressure bonding operation. Effective utilization of the protection sheets is hindered in such a case and, in particular, handling of panel substrates increased in size causes increase in areas of the protection sheets that are wound without being used and remarkable decrease in efficiency of utilization thereof. The decrease in efficiency of utilization of the protection sheets causes increase in frequency of replacement of the supply reel for the protection sheets and thus increase in frequency of operation stoppage of equipment for the replacement blocks increase in the production efficiency. Similarly, there is a fear that the increase in the number of the items also may block increase in the production efficiency in terms of the frequency of replacement of the supply reel for the protection sheets. Similar problems are caused as for apparatuses in which protection sheets are used, that is, ACF applying apparatuses and pressure bonding apparatuses such as component temporary pressure-bonding apparatuses.

### Solution to Problem

Therefore, it is an object of the invention to resolve problems described above and to provide a pressure bonding apparatus for pressing and pressure bonding objects by pressing members of pressure bonding units against and onto pressure bonding areas on edge portions of a substrate, by which apparatus production efficiency for the pressure bonding can be improved by efficient utilization of a protection sheet for protecting pressing surfaces of the pressing members in pressure bonding operations.

### Means to Solving the Problem

In order to achieve the object, the invention is configured as follows.

According to a first aspect of the present invention, there is provided a pressure bonding apparatus for pressing and pressure bonding objects against and onto pressure bonding areas on edge portions of a substrate, the pressure bonding apparatus comprising:

a plurality of pressure bonding units comprising pressing members including pressing surfaces for pressing the objects against the pressure bonding areas on the substrate and edge portion support members for supporting the edge portions of the substrate on occasion of pressure by the pressing members, the plurality of pressure bonding units arranged in a row along a first direction,

pressing member moving devices for moving the pressing members in a pressing direction perpendicular to the substrate and thereby pressing the objects,

a protection sheet supplying device for supplying along the first direction a protection sheet that has a width at least more than twice a width of the pressing surfaces of the pressing members in a second direction orthogonal to the first direction and that protects the pressing surfaces by being interposed between the pressing surfaces of the pressing members and the objects when the objects are pressed and for suspending the protection sheet under tension along the first direction between the plurality of pressing members and the edge portion support members, and

a second direction sheet moving device for moving the protection sheet in a range not smaller than the width of the pressing surfaces of the pressing members in the second direction and changing contact positions of the pressing members on the protection sheet in the second direction.

According to a second aspect of the present invention, there is provided a pressure bonding apparatus as defined in the first aspect, wherein the protection sheet supplying device moves the protection sheet in a range not less than a length of the pressing surfaces of the pressing members in the first direction and thereby changes the contact positions of the pressing members on the protection sheet in the first direction.

According to a third aspect of the present invention, there is provided a pressure bonding apparatus as defined in the first aspect, further comprising unit moving devices for moving the plurality of pressure bonding units along the first direction, wherein

the contact positions of the pressing members on the protection sheet are changed in the first direction by movement of the plurality of pressure bonding units along the first direction by the unit moving devices.

According to a forth aspect of the present invention, there is provided a pressure bonding apparatus as defined in the first aspect, wherein the second direction sheet moving device moves the protection sheet in the second direction by moving the protection sheet supplying device in the second direction and thereby changes the contact positions of the pressing members on the protection sheet in the second direction.

According to a fifth aspect of the present invention, there is provided a pressure bonding apparatus as defined in the first aspect, further comprising a plurality of unit moving devices that are provided individually and respectively for the plurality of pressure bonding units and that change an arrangement of the pressure bonding units by moving the pressure bonding units along the first direction with motions independent of one another, wherein

the contact positions of the pressing members on the protection sheet are changed in the first direction by movement and change in the arrangement of the plurality of pressure bonding units along the first direction by the plurality of unit moving devices.

According to a sixth aspect of the present invention, there is provided a pressure bonding apparatus as defined in the fifth aspect, wherein the substrate comprises a first edge portion on which the objects are to be bonded and a second edge portion which is provided so as to be orthogonal to the first edge portion and on which the objects are to be bonded, wherein

the pressure bonding apparatus further comprises a substrate holding device for holding the substrate and performing positioning between either one of the first edge portion and the second edge portion and the plurality of pressure bonding units by turning movement of the substrate along a surface of the substrate, and wherein

movement of the protection sheet by the second direction sheet moving device is performed with the turning movement of the substrate by the substrate holding device so that contact positions of the pressing surfaces on the protection sheet in an operation of pressure bonding the objects onto the first edge portion and the contact positions of the pressing surfaces on the protection sheet in an operation of pressure bonding the objects onto the second edge portion differ at least along the second direction.

According to a seventh aspect of the present invention, there is provided a pressure bonding apparatus as defined in the sixth aspect, wherein the movement of the plurality of pressure bonding units along the first direction by the plurality of unit moving devices is performed with the movement of the protection sheet by the second direction sheet moving device so that the contact positions of the pressing surfaces on the protection sheet in the operation of pressure bonding the objects onto the first edge portion and the contact positions of the pressing surfaces on the protection sheet in the operation of pressure bonding the objects onto the second edge portion differ along the first direction.

According to an eighth aspect of the present invention, there is provided a pressure bonding apparatus as defined in the first aspect, further comprising a control device that stores data of a maximum possible number of times of change of the contact positions of the pressing surfaces on the protection sheet in the second direction and controls the movement of the protection sheet by the second direction sheet moving device with reference to the stored data of the maximum possible number of times of the change.

According to a ninth aspect of the present invention, there is provided a pressure bonding apparatus as defined in the eighth aspect, wherein the control device determines whether a number of times of the change of the contact positions in the second direction exceeds the maximum possible number of times of the change and, upon determination of excess, controls the unit moving devices or the protection sheet supplying device to change the contact positions of the pressing surfaces of the pressing members on the protection sheet in the first direction.

According to a tenth aspect of the present invention, there is provided a pressure bonding apparatus as defined in the sixth or seventh aspect, wherein the control device selectably has two control modes of a pressure bonding operation tact priority mode and a protection sheet using efficiency priority mode as control modes, and wherein

the control device

upon selection of the pressure bonding operation tact priority mode, controls an operation of changing the contact positions of the pressing surfaces on the protection sheet by priority of the movement of the protection sheet along the first direction by the unit moving devices or the protection sheet supplying device over the movement of the protection sheet along the second direction by the second direction sheet moving device, on occasion of switching for carrying-in and carrying-out of the substrate or on occasion of the turning movement of the substrate by the substrate holding device for the operation of pressure bonding onto the second edge portion of the substrate subsequent to the operation of pressure bonding onto the first edge portion of the substrate, and

upon selection of the protection sheet using efficiency priority mode, controls the operation of changing the contact positions of the pressing surfaces on the protection sheet by priority of the movement of the protection sheet along the second direction by the second direction sheet moving device over the movement of the protection sheet along the first direction by the unit moving devices or the protection sheet supplying device, on occasion of the switching for the carrying-in and the carrying-out of the substrate or on occasion of the turning movement of the substrate by the substrate holding device for the operation of pressure bonding onto the second edge portion of the substrate subsequent to the operation of pressure bonding onto the first edge portion of the substrate.

According to an eleventh aspect of the present invention, there is provided a component pressure bonding apparatus as defined in any one of the first through ninth aspects, wherein the objects that are to be press-bonded are electronic components, and wherein the plurality of electronic components placed on the edge portions of the substrate are pressed, press-bonded and mounted on the edge portions of the substrate by the plurality of pressure bonding units.

According to a twelfth aspect of the present invention, there is provided a joining sheet pressure bonding apparatus as defined in any one of the first through ninth aspects, wherein the objects that are to be press-bonded are joining sheets for joining electronic components onto the substrate, and wherein the plurality of joining sheets placed between the edge portions of the substrate and the pressing members are pressed, press-bonded and applied on the edge portions of the substrate by the plurality of pressure bonding units.

According to a 13th aspect of the present invention, there is provided a pressure bonding method for pressing and pressure bonding a plurality of objects onto pressure bonding areas on edge portions of a substrate, the pressure bonding method comprising:

performing positioning of a plurality of pressure bonding units comprising pressing members including pressing surfaces for pressing the objects against the pressure bonding areas on the substrate and edge portion support members for supporting the edge portions of the substrate on occasion of pressure by the pressing members, the plurality of pressure bonding units arranged in a row along a first direction, relative to pressure bonding positions of the plurality of objects on the edge portions of the substrate,

pressing and pressure bonding the plurality of objects against and onto the edge portions of the substrate by the pressing surfaces of the plurality of pressing members while protecting the pressing members by a protection sheet in a state in which the protection sheet that has a width at least more than twice a width of the pressing surfaces of the pressing members in a second direction orthogonal to the first direction is placed along the first direction between the plurality of the pressing members and the edge portion support members,

changing contact positions of the pressing members on the protection sheet in the second direction by moving the protection sheet in the second direction at least by a distance not smaller than the width of the pressing surfaces of the pressing members for subsequent pressure bonding on other pressure bonding areas on the edge portions of the substrate, and

thereafter pressing and pressure bonding a plurality of objects against and onto said other pressure bonding areas on the edge portions through the protection sheet by the pressing surfaces of the plurality of pressing members.

According to a 14th aspect of the present invention, there is provided a pressure bonding method as defined in the 13th aspect, wherein the contact positions of the pressing members on the protection sheet are changed in the first direction by movement of the protection sheet in the first direction by a distance not smaller than a length of the pressing surfaces of the pressing members, after pressure bonding of the plurality of objects onto said other pressure bonding areas, for subsequent pressure bonding on still other pressure bonding areas on the edge portions of the substrate, and wherein

a plurality of objects are thereafter pressed against and press-bonded onto said still other pressure bonding areas on the edge portions through the protection sheet by the pressing surfaces of the plurality of pressing members.

According to a 15th aspect of the present invention, there is provided a pressure bonding method as defined in the 13th aspect, wherein the contact positions of the pressing members on the protection sheet are changed in the first direction or in the second direction on occasion of movement and change in arrangement of the plurality of pressure bonding units along the first direction for positioning between pressure bonding positions of the plurality of objects on said other pressure bonding areas on the edge portions of the substrate and the plurality of pressure bonding units.

According to a 16th aspect of the present invention, there is provided a pressure bonding method as defined in the 13th aspect, wherein the substrate comprises a first edge portion having a pressure bonding area on which the objects are to be bonded and a second edge portion provided so as to be orthogonal to the first edge portion and having another pressure bonding area on which the objects are to be bonded, wherein

positioning between pressure bonding positions of the plurality of objects on said another pressure bonding area on the second edge portion and the plurality of pressure bonding units is performed by positioning of the second edge portion between the plurality of pressure bonding members and the edge portion support members by turning movement of the substrate along a surface of the substrate, and wherein

an operation of changing the contact positions of the pressing members on the protection sheet in the second direction is performed with the turning movement of the substrate.

According to a 17th aspect of the present invention, there is provided a pressure bonding method as defined in the 16th aspect, wherein either one of two control modes including a pressure bonding operation tact priority mode and a protection sheet using efficiency priority mode is selected as a control mode for pressure bonding operations when the pressure bonding operations are started, wherein

upon selection of the pressure bonding operation tact priority mode, the operation of changing the contact positions of the pressing surfaces on the protection sheet is controlled by priority of movement of the protection sheet along the first direction over movement of the protection sheet along the second direction on occasion of the turning movement of the substrate for the pressure bonding operation for the second edge portion of the substrate subsequent to the pressure bonding operation for the first edge portion of the substrate, and wherein

upon selection of the protection sheet using efficiency priority mode, the operation of changing the contact positions of the pressing surfaces on the protection sheet is controlled by priority of the movement of the protection sheet along the second direction over the movement of the protection sheet along the first direction on occasion of the turning movement of the substrate for the pressure bonding operation for the second edge portion of the substrate subsequent to the pressure bonding operation for the first edge portion of the substrate.

### EFFECT OF THE INVENTION

According to the pressure bonding apparatus of the invention, the plurality of pressure bonding units are provided therein that have the pressing members along the first direction along the edge portion of the substrate, the protection sheet is used therein that has the width at least more than twice the width of the pressing surfaces of the pressing members in the second direction orthogonal to the first direction and that is supplied and placed along the first direction between the pressing surfaces of the plurality of the pressing members and the objects, and the second direction sheet moving device is provided therein for advancing and reversing the protection sheet in the range not smaller than the width of the pressing surfaces of the pressing members in the second direction and changing the contact positions of the pressing members on the protection sheet in the second direction. Thus the protection sheet that is supplied along the first direction in which the plurality of pressure bonding units are arranged is moved at least in the second direction that is the direction of the width thereof, so that the efficiency of utilization can be increased by the change in the contact positions with respect to the pressing members. Such change of the contact positions in the second direction, which can be attained by the movement of the protection sheet in the second direction, reduces a distance of the movement of the protection sheet and thus can be attained in a comparatively short period of time, in comparison with the operation of feeding the protection sheet in the first direction.

Accordingly, the efficient utilization of the protection sheet in the pressure bonding apparatus can be attained and the pressure bonding apparatus by which productivity can be improved can be provided.

According to the pressure bonding method of the invention, the plurality of pressure bonding units are provided therein that have the pressing members along the first direction along the edge portion of the substrate, the protection sheet is used therein that has the width at least more than twice the width of the pressing surfaces of the pressing members in the second direction orthogonal to the first direction and that is supplied and placed along the first direction between the pressing surfaces of the plurality of the pressing members and the objects, and the protection sheet is advanced and reversed in the range not smaller than the width of the pressing surfaces of the pressing members in the second direction so that the contact positions of the pressing members on the protection sheet can be changed in the second direction. Thus the protection sheet that is supplied along the first direction in which the plurality of pressure bonding units are arranged is moved at least in the second direction that is the direction of the width thereof, so that the efficiency of utilization can be increased by the change in the contact positions with respect to the pressing members. Such change of the contact positions in the second direction, which can be attained by the movement of the protection sheet in the second direction, reduces the distance of the movement of the protection sheet and thus can be attained in a comparatively short period of time, in comparison with the operation of feeding the protection sheet in the first direction.

Accordingly, the efficient utilization of the protection sheet in the pressure bonding can be attained and the pressure bonding method by which productivity can be improved can be provided.

### BRIEF DESCRIPTION OF DRAWINGS

These aspects and features of the invention will be apparent from the following description concerning preferred embodiments with reference to the accompanying drawings, in which:

FIG. 1 is an external view of a panel substrate that is handled in a component mounting line in accordance with a first embodiment of the invention;

FIG. 2 is a schematic illustration of outer lead bonding processes in the first embodiment;

FIG. 3 is an external view of a final pressure-bonding apparatus in accordance with the first embodiment;

FIG. 4 is a schematic side view of the final pressure-bonding apparatus in accordance with the first embodiment, as seen looking from an X-axis direction;

FIG. 5 is a schematic front view of the final pressure-bonding apparatus in accordance with the first embodiment, as seen looking from a Y-axis direction;

FIG. 6 is a schematic side view of the final pressure-bonding apparatus in accordance with the first embodiment, as seen looking from the X-axis direction;

FIG. 7 is a schematic side view of the final pressure-bonding apparatus (in protection sheet replacing status) in accordance with the first embodiment, as seen looking from the X-axis direction;

FIG. 8 is a flow chart showing procedures of a final pressure bonding method in accordance with the first embodiment;

FIG. 9A is a schematic illustration of status in which a final pressure bonding operation is performed for a long side terminal portion of the panel substrate;

FIG. 9B is a schematic illustration showing details of the long side terminal portion of the panel substrate;

FIG. 10A is a schematic illustration of status in which a final pressure bonding operation is performed for a short side terminal portion of the panel substrate;

FIG. 10B is a schematic illustration showing details of the short side terminal portion of the panel substrate;

FIG. 11A is a schematic plan view showing an arrangement of contact positions of pressure bonding heads on a protection sheet in the final pressure bonding method in accordance with the first embodiment;

FIG. 11B is a schematic plan view showing an arrangement of contact positions of the pressure bonding heads on the protection sheet in the final pressure bonding method in accordance with the first embodiment;

FIG. 11C is a schematic plan view showing an arrangement of contact positions of the pressure bonding heads on the protection sheet in the final pressure bonding method in accordance with the first embodiment;

FIG. 11D is a schematic plan view showing an arrangement of contact positions of the pressure bonding heads on the protection sheet in the final pressure bonding method in accordance with the first embodiment;

FIG. 12A is a schematic plan view showing an arrangement of contact positions of the pressure bonding heads on the protection sheet in a final pressure bonding method in accordance with a modification of the first embodiment;

FIG. 12B is a schematic plan view showing an arrangement of contact positions of the pressure bonding heads on the protection sheet in the final pressure bonding method in accordance with the modification of the first embodiment;

FIG. 12C is a schematic plan view showing an arrangement of contact positions of the pressure bonding heads on the protection sheet in the final pressure bonding method in accordance with the modification of the first embodiment;

FIG. 12D is a schematic plan view showing an arrangement of contact positions of the pressure bonding heads on the protection sheet in the final pressure bonding method in accordance with the modification of the first embodiment;

FIG. 13 is a schematic fragmentary front view of a final pressure-bonding apparatus in accordance with a modification of the first embodiment;

FIG. 14 is a schematic fragmentary plan view of the final pressure-bonding apparatus in accordance with the modification of the first embodiment;

FIG. 15 is a flow chart of ordinary determination processing that is applied to a main bonding method in accordance with a second embodiment of the invention;

FIG. 16 is a flow chart of determination processing of an option 1 that is applied to the main bonding method in accordance with the second embodiment;

FIG. 17 is a flow chart of determination processing of an option 2 that is applied to the main bonding method in accordance with the second embodiment;

FIG. 18 is a schematic diagram of the protection sheet for illustrating the main bonding method of the second embodiment;

FIG. 19 is a schematic diagram of the protection sheet for illustrating the main bonding method of the second embodiment; and

FIG. 20 is a schematic diagram of the protection sheet for illustrating the main bonding method of the second embodiment.

### EMBODIMENT FOR CARRYING OUT THE INVENTION

Prior to continuation of description of the invention, the same components through the accompanying drawings are designated by the same reference characters.

Hereinbelow, embodiments of the invention will be described in detail with reference to the drawings.

### First Embodiment

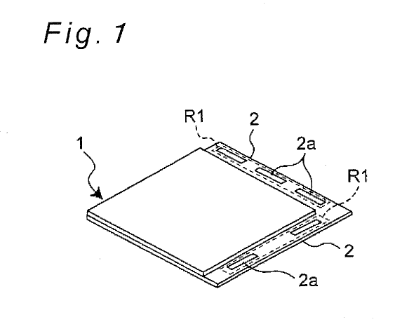

A component pressure bonding apparatus and a component pressure bonding method will be described as an example of a pressure bonding apparatus and a pressure bonding method in accordance with a first embodiment of the invention. Initially, a form of a panel substrate 1 that is handled in the component pressure bonding apparatus and the component pressure bonding method and a summary of a pressure bonding processing (or a mounting processing) that is performed on the panel substrate 1 will be described with reference to FIG. 1 showing an appearance of the panel substrate 1.

As shown in FIG. 1, the substrate that is handled in the first embodiment is a substrate (which will be referred to as “panel substrate”) 1 typified by liquid crystal display (LCD) panel substrate, plasma display panel (PDP) substrate and the like, and the substrate has terminal portions 2, provided with component mounting areas R1 to be mounted with components, on edge portions on adjoining two sides of a rectangular shape. The panel substrate 1 commonly has a rectangular shape, and the terminal portions 2 are formed as a long side terminal portion (that is a terminal portion shown on deep side in FIG. 1 and is an example of the first edge portion) and as a short side terminal portion (that is a terminal portion shown on front side in FIG. 1 and is an example of the second edge portion). A plurality of terminal electrodes 2a are formed on each of the terminal portions 2, and the components are electrically connected to the terminal electrodes 2a by being press-bonded and mounted thereon. An area of the panel substrate 1 that is inside the edge portions is a display area on which images such as pictures and character information are displayed. The panel substrate 1 is chiefly formed of glass material, and a thickness of such a substrate has been decreased so as to be not larger than 0.5 mm, for instance. Though the panel substrate 1 has the terminal portions 2, provided with the component mounting areas R1 to be mounted with components, on the edge portions on the adjoining two sides of the rectangular shape, for instance, in the example, a panel substrate (not shown), provided with a component mounting area R1 to be mounted with components, on an edge portion on at least one side thereof can be handled.

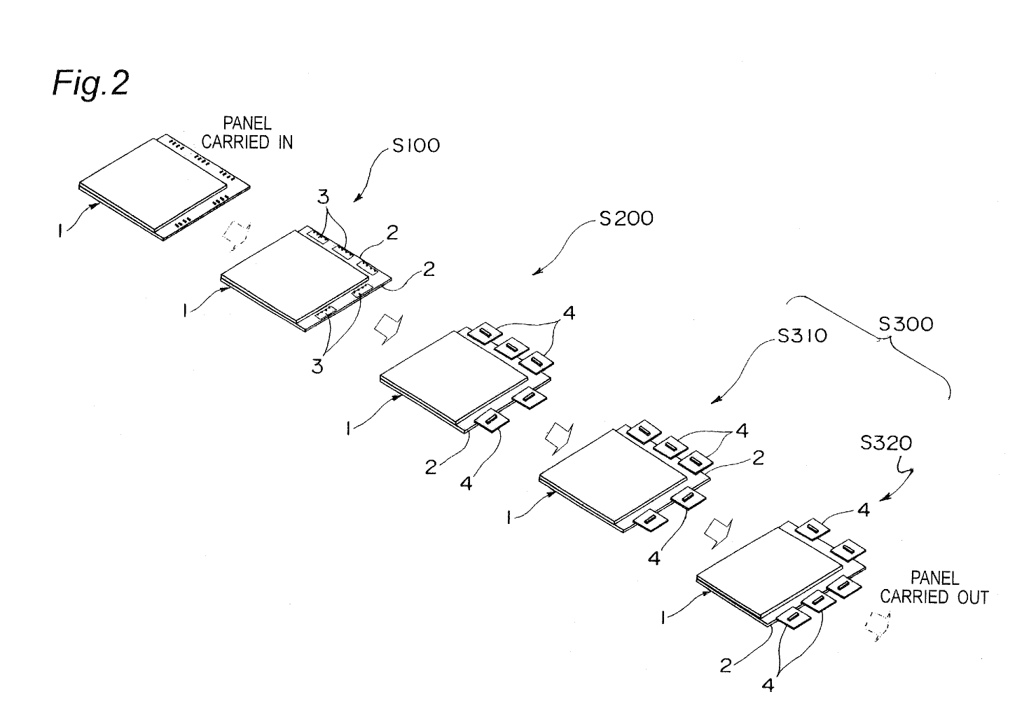

FIG. 2 shows an illustration showing procedures of component mounting processes, for the panel substrate 1 having such a structure, including the component pressure bonding method in accordance with the first embodiment.

For the panel substrate 1 carried into apparatuses for performing the component mounting processes, as shown in FIG. 2, ACF sheets 3 as joining members are applied on the terminal electrodes 2a of the terminal portions 2 in an ACF applying process 5100 as an example of the joining member placing process, TCPs 4, for instance, as the components are thereafter temporarily press-bonded onto the terminal electrodes 2a through the ACF sheets 3 in a component temporary pressure bonding process 5200 as an example of the component pressure bonding process, and the temporarily press-bonded TCPs 4 are thereafter further press-bonded and mounted in a final pressure bonding process 5300. The final pressure bonding process 5300 is performed with division thereof into a final pressure bonding process 5310 for the long side terminal portion of the panel substrate 1 and a final pressure bonding process 5320 for the short side terminal portion of the panel substrate 1. Such processes of mounting the TCPs 4 on the panel substrate 1 are referred to as outer lead bonding processes.

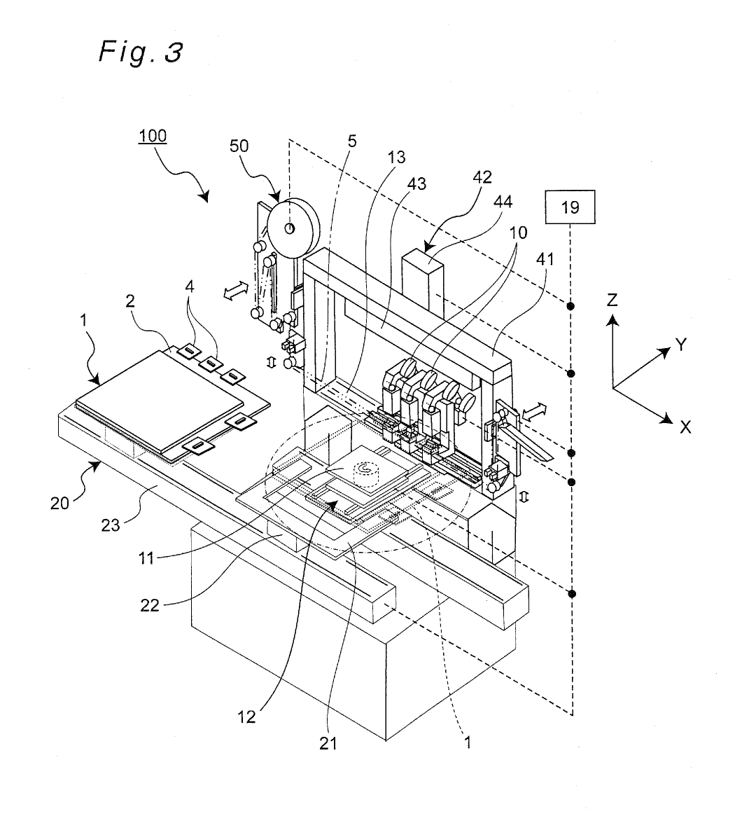

Subsequently, FIG. 3 shows a schematic diagram showing a configuration of a final pressure-bonding apparatus 100 that is an example of the component pressure bonding apparatus for performing the final pressure bonding processes as such outer lead bonding processes.

The final pressure-bonding apparatus 100 has a plurality of (e.g., three) pressure bonding units 10 for performing final pressure bonding, i.e., thermal pressure bonding (mounting) of the TCPs 4 on the terminal electrodes 2a through the ACF sheets 3 by heating while pressing the TCPs 4 temporarily press-bonded through the ACF sheets 3 onto the long side and the short side terminal portions 2 of the panel substrate 1, a stage 11 for holding the panel substrate 1 that is transferred (carried in), and a panel substrate holding device 12 for performing positioning of the TCPs 4, temporarily press-bonded on the terminal portions 2 of the panel substrate 1 held by the stage 11, relative to the pressure bonding units 10. The panel substrate holding device 12 has a function of moving the panel substrate 1 in an X-axis direction or a Y-axis direction shown in the drawing (X-Y moving function), a function of turning the panel substrate 1 in a plane (horizontal plane) including the X-axis direction and the Y-axis direction (e-turning function), and a function of moving up and down the panel substrate 1 in a Z-axis direction (up-and-down function), and such functions make it possible to attain positioning of the long side and short side terminal portions 2 of the panel substrate 1 with respect to the pressure bonding units 10. In the final pressure-bonding apparatus 100 are provided recognition cameras (not shown) for recognizing positions of the terminal portions 2 of the panel substrate 1 in order to facilitate such positioning. In FIG. 3, the X-axis direction and the Y-axis direction are generally along a surface of the panel substrate 1, the panel substrate 1 is conveyed in the X-axis direction (first direction), the Y-axis direction (second direction) is orthogonal to the X-axis direction, and a vertical direction in the drawing is the Z-axis direction.

In the final pressure-bonding apparatus 100 (or the component mounting line) is provided a substrate conveyor device 20 for carrying-in and carrying-out of the panel substrate 1 between the apparatuses that perform the processes. The substrate conveyor device 20 has a panel holding unit 21 for releasably sucking and holding a lower surface of the panel substrate 1 by vacuum suction means (not shown), an up-and-down unit 22 for moving up and down the panel holding unit 21, and a moving device 23 for transferring the panel substrate 1 between the apparatuses by moving the panel holding unit 21 and the up-and-down unit 22 along the X-axis direction shown in the drawing. Though the panel holding unit 21 that holds the panel substrate 1 by the vacuum suction means is described as an example for the first embodiment, the panel substrate 1 may alternatively be held by a panel holding unit having mechanical chuck means.

In the final pressure-bonding apparatus 100 is provided a protection sheet supplying device 50 for suspending a protection sheet 5 under tension, which is interposed between the pressure bonding units 10 and the TCPs 4 in order to prevent dirt and the like from adhering to the pressure bonding units 10 in an operation of pressure bonding the TCPs 4 by the pressure bonding units 10, along the X-axis direction and simultaneously performing a feeding operation for supply and retrieval thereof.

In the final pressure-bonding apparatus 100 is provided a control device 19 for generally controlling operations of component units such as the pressure bonding units 10 while relating the control to mutual operations. While the operations of the pressure bonding units 10 and/or the like are individually or generally controlled by the control device 19, the final pressure bonding process is performed for the panel substrate 1 carried into the final pressure-bonding apparatus 100.

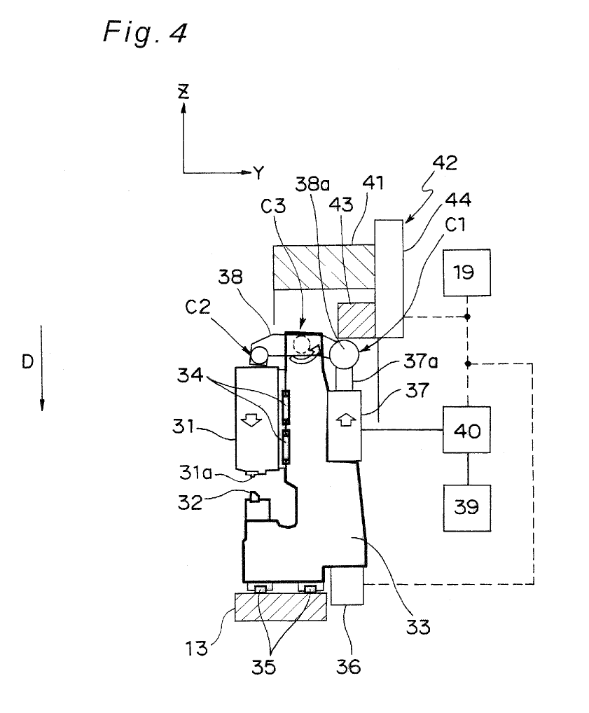

FIG. 4 shows a schematic side view of a pressure bonding unit 10 the final pressure-bonding apparatus 100 includes, and configurations of the final pressure-bonding apparatus 100 and the pressure bonding units 10 will be described further in detail with reference to FIGS. 3 and 4.

As shown in FIGS. 3 and 4, the final pressure-bonding apparatus 100 has three pressure bonding units 10 in total, for instance, as the plurality of pressure bonding units 10, arranged in a row along the X-axis direction. Each of the pressure bonding units 10 has a pressure bonding head 31 including a pressure bonding tool 31a, as an example of the pressing member for pressing and pressure bonding the TCP 4 temporarily press-bonded through the ACF sheet 3 onto the terminal portion 2 of the panel substrate 1, on an end thereof on pressing side, and a backup stage 32 as an example of the edge portion support member for supporting the terminal portion 2 of the panel substrate 1 from the lower surface side thereof.

In each of the pressure bonding units 10, as shown in FIG. 4, the backup stage 32 is fixed to lower part of a unit frame 33 that is a columnar body formed of a rigid body and having a section generally shaped like a letter L, and the pressure bonding head 31 is mounted on upper part of the unit frame 33 (as an example of the unit support member) through LM guides 34 (as an example of the pressing member guide members) placed along the Z-axis direction so that operations of moving up and down the head can be guided. Though a configuration in which the backup stage 32 is fixed to the lower part of the unit frame 33 is described for the first embodiment, the backup stage 32 may alternatively be supported by the unit frame 33 so as to be vertically movable, for instance, so that operations of moving up and down the backup stage 32 are performed by a backup stage up-and-down unit. The plurality of pressure bonding units 10 each have the pressure bonding head 31 and the backup stage 32 as the example of the edge portion support member; however, a common edge portion support member may be provided for the plurality of pressure bonding heads 31.

As shown in FIGS. 3 and 4, two LM guides 35 are provided on a base frame 13 of the final pressure-bonding apparatus 100 so as to extend in the X-axis direction, and the unit frames 33 of the three pressure bonding units 10 are supported by the base frame 13 through the LM guides 35 (as an example of the guiding support members) so as to be capable of advancing and reversing in the X-axis direction. As shown in FIG. 4, a unit moving motor (as an example of the unit moving device) 36 for driving the advance and reverse of each pressure bonding unit 10 in the X-axis direction is provided on the lower part of the unit frame of the pressure bonding unit 10. That is, the three pressure bonding units 10 individually have the pressure bonding head 31 and the backup stage 32 and are configured so as to be capable of moving back and forth independently of each other while being guided in the X-axis direction along the two LM guides 35, by actuation of the unit moving motors 36 provided individually. Herein, “moving independently of each other” refers to movement in which one pressure bonding unit 10 is moved by actuation of the unit moving motor 36 the unit itself has, in which another pressure bonding unit 10 is moved by actuation of the unit moving motor 36 the unit itself has, and in which velocities and timing of the movement of both can separately be set. Control over the movement of both may be related to each other for achievement of safe control such as prevention of contact between the pressure bonding units 10.

As shown in FIG. 4, the pressure bonding units 10 are each provided with a pressure applying unit (e.g., air cylinder) 37 as an example of the fluid pressure cylinder for applying to the pressure bonding head 31a force for causing advance and reverse, i.e., vertical movement of the pressure bonding head 31 in a pressing direction D that is a direction (Z-axis direction) perpendicular to the panel substrate 1 placed horizontally in general and for applying a force for final pressure bonding to the pressure bonding head 31 brought into contact with the TCP 4. The pressure applying unit 37 is positioned opposite to the pressure bonding head 31 with respect to the unit frame 33 along the Y-axis direction and is fixed to the unit frame 33. In FIG. 4, namely, the pressure bonding head 31 is placed on left side of the unit frame 33 in the drawing and the pressure applying unit 37 is placed on right side of the unit frame 33 in the drawing.

In each pressure bonding unit 10, as shown in FIG. 4, a link mechanism is employed as means for mechanically transmitting the force produced in the pressure applying unit 37 to the pressure bonding head 31. Specifically, the link mechanism is configured by a lever (as an example of the lever member) that is pivotably supported, at vicinity of center thereof in general, on an upper end of the unit frame 33, that is pivotably connected, at a left end thereof in the drawing, to upper part of the pressure bonding head 31, and that is pivotably connected, at a right end thereof in the drawing, to an end of a rod 37a connected to a piston inside the pressure applying unit 37. The lever 38 is positioned along the Y-axis direction in general and the pivotal motions at positions of the support and connection thereof can be performed in a Y-Z plane. Such a configuration of the link mechanism makes it possible to transmit the force produced in the pressure applying unit 37 through the lever 38 to the pressure bonding head 31 with use of a position C1 of the connection between the rod 37a of the pressure applying unit 37 and the lever 38 as a “point of pressure,” a position C2 of the connection between the pressure bonding head 31 and the lever 38 as a “point of action,” and a position C3 of the support by the unit frame 33 for the lever 38 as a “fulcrum.” That is, the force produced in the pressure applying unit 37 and acting in the Z-axis direction can be transmitted through the lever 38 to the pressure bonding head 31 while the direction of the force is inverted by the lever 38, so that the pressure bonding head 31 can be moved along the pressing direction D. The employment of such a configuration by which the force produced in the pressure applying unit 37 placed on one side of the unit frame 33 can be transmitted to the pressure bonding head 31 placed on the other side thereof with use of the lever 38 supported on the upper part of the unit frame 33 makes it possible to make a structure of the whole pressure bonding unit 10 short and compact and to attain a satisfactory load balance in the pressure bonding unit 10. This allows the pressure bonding unit 10 to have a reduced size and a lower center of gravity, so that a velocity or an efficiency of movement of the pressure bonding unit 10 in the X-axis direction can be increased.

As shown in FIG. 4, the pressure applying unit 37 each pressure bonding unit 10 has is connected to a pressure source 39 through a connecting pipe or the like, and a quantity of supply of compressed air therefor is controlled so that a desired force (pressure) can be produced with control by a pressure control unit 40.

As shown in FIGS. 3 and 4, a gate-shaped frame 41 formed of rigid body members and having a gate-like shape in general is fixed onto the base frame 13 so as to extend along the X-axis direction, and the three pressure bonding units 10 are arranged inside the gate-shaped frame 41. On the gate-shaped frame 41 is provided a head motion restricting device 42 (as an example of the motion velocity restricting device) that is capable of restricting motions of the pressure bonding heads 31 along the pressing direction D by restricting the pivotal motions of the levers 38 on the support positions C3 by contact with the levers 38. The head motion restricting device 42 has one restricting member 43 that is provided so as to extend in the X-axis direction inside the gate-shaped frame 41 and that is a bar-like member capable of coming into contact with upper parts of end portions 38a of the levers 38 of the three pressure bonding units 10 at the positions C1 of the connection, and a restricting member up-and-down device 44 for causing rising and lowering motions (advancing and reversing movement along the pressing direction D) of the restricting member 43.

The head motion restricting device 42 having such a configuration can be used to restrict rising velocities of the end portions 38a of the levers 38 to a desired velocity by lowering the restricting member 43 by the restricting member up-and-down device 44, bringing lower part of the restricting member 43 into contact with the upper parts of the end portions 38a of the levers 38, transmitting pressures to the levers 38 by the pressure applying unit 37 in a state of the contact, and moving up the restricting members 43 at the desired velocity by the restricting member up-and-down device 44. In a configuration in which the levers 38 are moved by pressures of fluid as in the pressure applying unit 37, in particular, it is difficult to control the motion velocities of the levers 38. Therefore, the first embodiment employs the head motion restricting device 42 in order that the motion velocities of the levers 38 may reliably be controlled. A velocity at which the levers 38 pivot on the support positions C3 can be restricted by such restriction of the motion velocities of the levers 38, so that motion velocities (lowering velocities) of the pressure bonding heads 31 in a direction toward the backup tools 32 can be restricted to a specified velocity. The restricting member 43 is configured so that the lower part thereof is brought into contact with the end portions 38a of the levers 38, and thus the motion velocities are restricted when the motions of the pressure bonding heads 31 toward the backup tools 32 are brought about. Once the restricting member 43 is moved up by the restricting member up-and-down device 44 so as to be spaced apart from the end portions 38a of the levers 38, the restriction on the motions of the levers 38 can be released. That is, the restricting member 43 can be made to advance and reverse by the restricting member up-and-down device 44 between a position of the contact with the levers 38 and a shelter position alienated from the levers 38. As shown in FIG. 3, the head motion restricting device 42 is not provided separately for each of the pressure bonding units 10 but one head motion restricting device 42 common to the three pressure bonding units 10 is provided. The provision of the one common head motion restricting device 42 allows attainment of simplification of the configuration and reduction in the size of the individual pressure bonding units 10, quick movement of the pressure bonding units 10 in the X-axis direction, and the like.

The control device 19 acquires information on positions of the pressure bonding units 10 in the X-axis direction that result from the movement thereof caused by the unit moving motors 36 and controls the movement so that the pressure bonding units 10 may not interfere with one another. The control device 19 generally controls the integrated or individually independent restriction on the motion velocities of the pressure bonding heads 31 by the head motion restricting device 42 and the control over the pressures by the pressure control unit 40.

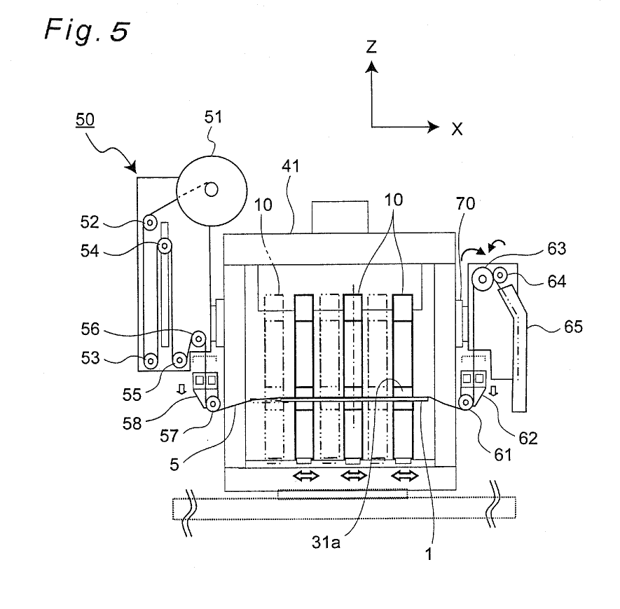

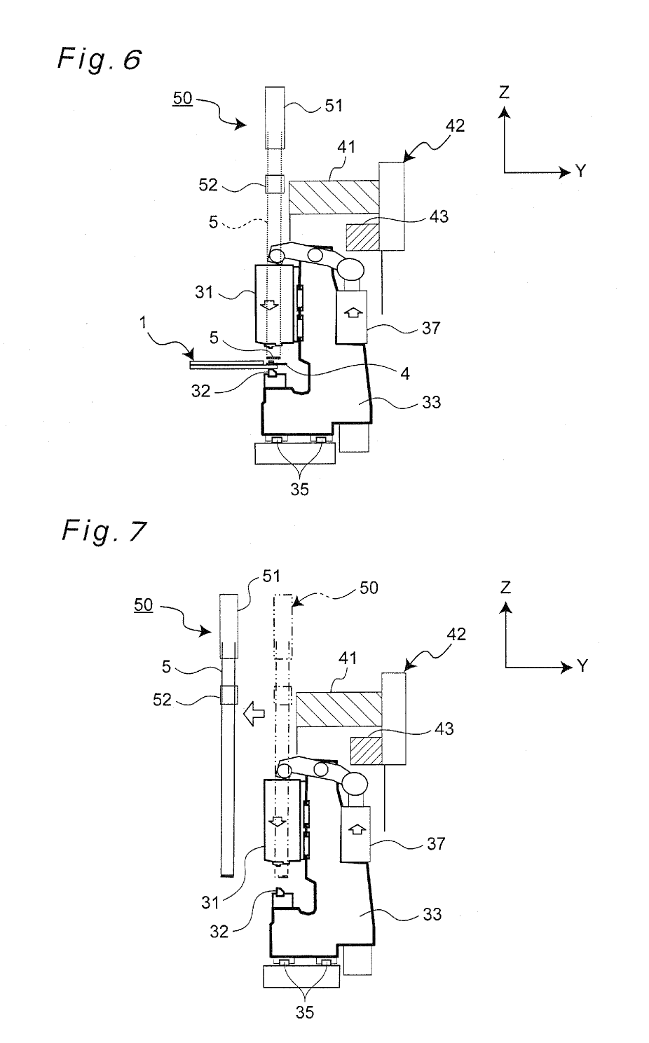

Subsequently, a configuration of the protection sheet supplying device 50 the final pressure-bonding apparatus 100 includes will be described in detail with reference to a schematic front view of the protection sheet supplying device 50 shown in FIG. 5 and a schematic side view thereof shown in FIG. 6.

As shown in FIGS. 5 and 6, the protection sheet supplying device 50 has a supply reel 51 in which the wound protection sheet 5 is accommodated so that the sheet can be supplied therefrom and a collecting unit 65 by which the spent protection sheet 5 that has been supplied from the supply reel 51 and has been used in the pressure bonding operations by the pressure bonding units 10 is collected. In FIG. 5, the supply reel 51 is placed on left side of the gate-shaped frame 41 in the drawing, the collecting unit 65 is placed on right side of the gate-shaped frame 65 in the drawing, and a conveying path through which the protection sheet 5 is fed and conveyed is formed between both.

The protection sheet supplying device 50 of FIG. 5 has a plurality of rollers 52 through 56 placed sequentially along the conveying path from the supply reel 51, rollers 63 and 64 placed on the conveying path in vicinity of the collecting unit 65, two suspending rollers 57, 61 for suspending and supporting the protection sheet 5 under tension in a generally horizontal position between the pressure bonding heads 31 and the backup stages 32 in the gate-shaped frame 41, and up-and-down units 58, 62 for moving up and down the two suspending rollers 57, 61. Moving down the suspending rollers 57 and 61 by the up-and-down units 58 and 62 brings the suspended protection sheet into contact with the terminal portion 2 of the panel substrate 1 placed on the backup stages 32 as shown in FIG. 5, and moving up the suspending rollers 57 and 61 causes the protection sheet 5 to be spaced apart from the terminal portion 2 of the panel substrate 1 and allows the panel substrate 1 or the protection sheet 5 to be moved. A specified tension is imparted to the protection sheet 5 suspended between the suspending rollers 57 and 61.

In the protection sheet supplying device 50 having such a configuration, the spent protection sheet 5 can be collected into the collecting unit 65 by any of the rollers as a driving device, e.g., by rotational drive of the roller 63 as a driving roller, and a fresh (unused) portion of the protection sheet 5 can be supplied and placed along the X-axis direction between the suspending rollers 57 and 61 by feeding of the fresh protection sheet 5 from the supply reel 51 into the conveying path.

The final pressure-bonding apparatus 100 has a Y-axis direction sheet moving device (as an example of the second direction sheet moving device) 70 for causing advance and reverse movement of the protection sheet 5 on the conveying path in the Y-axis direction. Specifically, the Y-axis direction sheet moving device 70 causes integrated advance and reverse movement in the Y-axis direction of the supply reel 51, the rollers 52 through 56, the suspending rollers 57, 61, the up-and-down units 58, 62, the rollers 63, 64, and the collecting unit 65, that is, causes advance and reverse movement in the Y-axis direction of the protection sheet supplying device 50.

In the final pressure-bonding apparatus 100 of the first embodiment, a protection sheet having a width at least more than twice that of pressing surfaces of the pressure bonding heads 31 in the Y-axis direction is used as the protection sheet 5. That is, the protection sheet 5 has the width in which at least two areas that can be brought into contact with the pressure bonding heads 31 can be obtained along a direction of the width thereof. Specifically, the protection sheet 5 has the width in which the two areas that can be brought into contact with the pressing surfaces of the pressure bonding tools 31a of the pressure bonding heads 31 can be arranged side by side along the direction of the width.

By the advance and reverse movement of the protection sheet 5 having such a width in the Y-axis direction by the Y-axis direction sheet moving device 70, contact positions of the pressure bonding heads 31 on the protection sheet 5 can be changed within the width of the protection sheet 5 in the direction of the width. Specific details of an operation of changing the contact positions will be described later. As shown in a schematic side view of the protection sheet supplying device 50 of FIG. 7, the suspended protection sheet 5 can greatly be moved from between the pressure bonding heads 31 and the backup stages 32 by movement of the Y-axis direction sheet moving device 70 in the Y-axis direction leftward in the drawing beyond a range of the width of the protection sheet 5. In a state in which the protection sheet supplying device 50 has been moved as a whole, as shown in FIG. 7, an operation of replacement of the protection sheet 5, various maintenance operations for the protection sheet supplying device 50, and the like can efficiently be performed, for instance. A position of the protection sheet 5 along the Y-axis direction that results from the movement thereof by the Y-axis direction sheet moving device 70 is controlled by the control device 19.

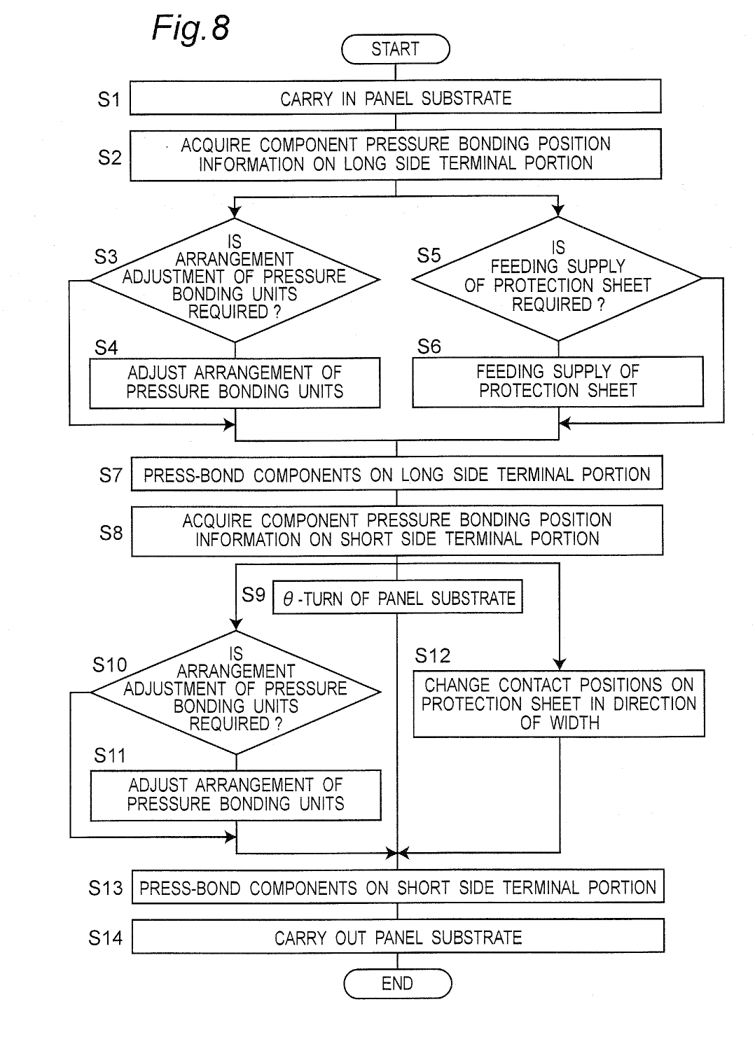

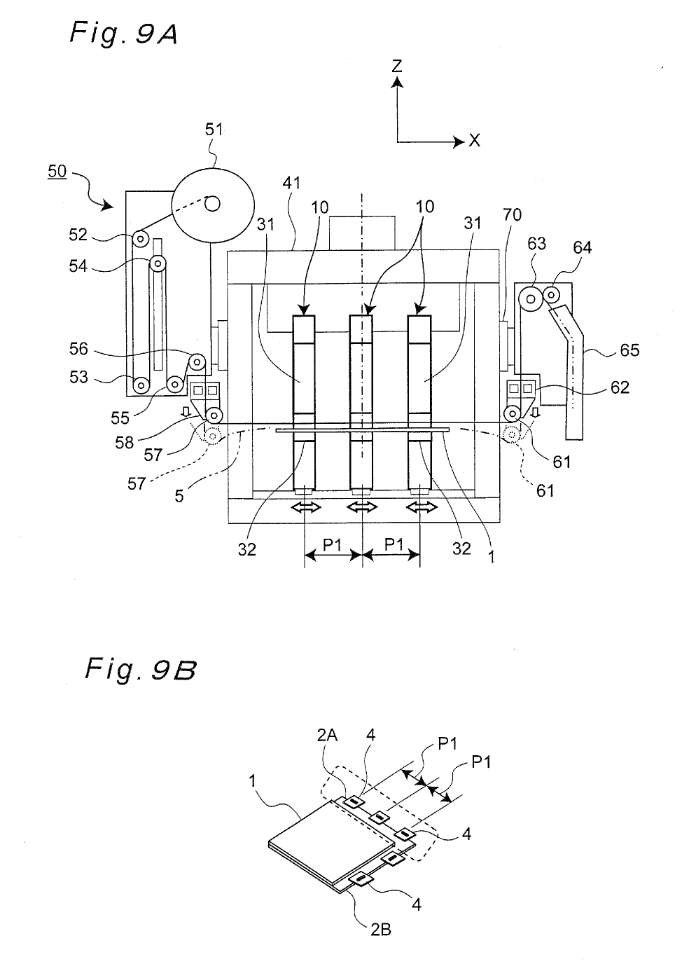

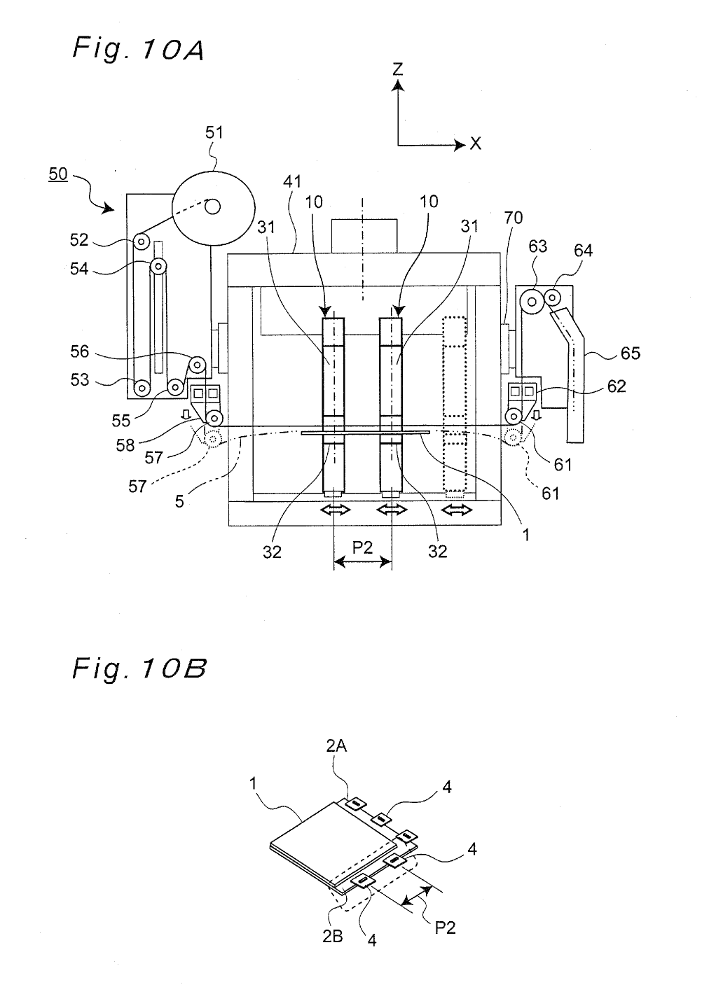

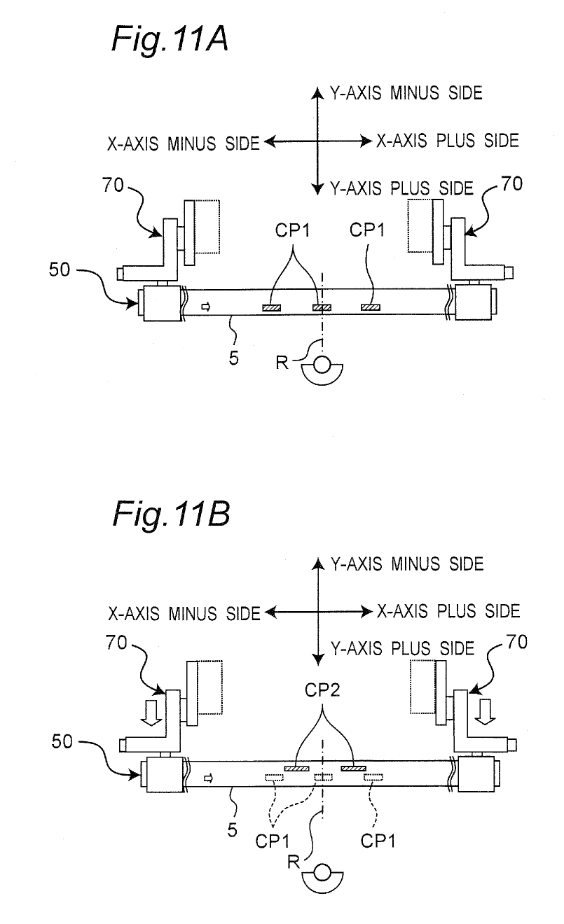

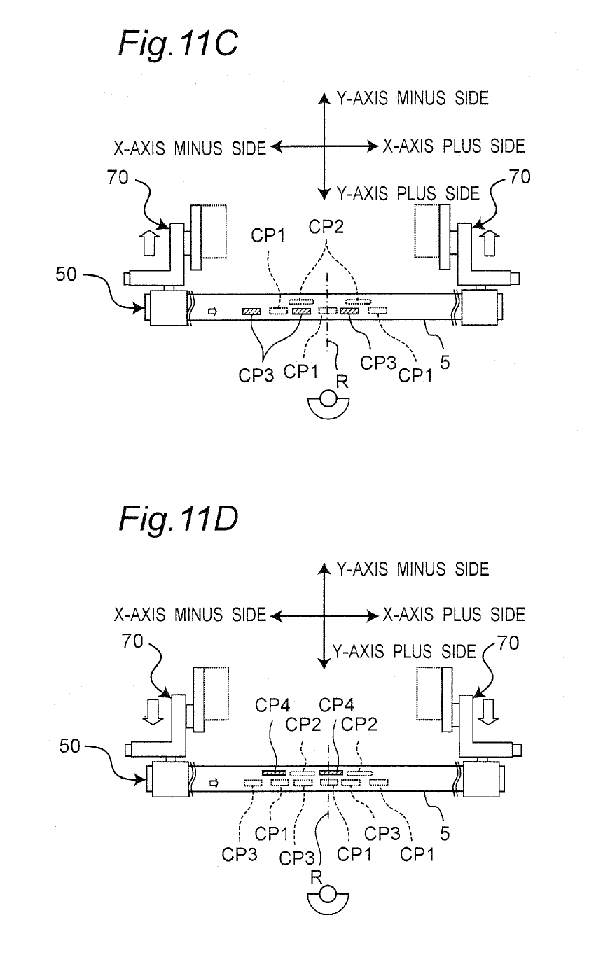

Subsequently will be described specific procedures of performing the final pressure bonding process S300 (S310 and S320), in the final pressure-bonding apparatus 100 having such a configuration, for the panel substrate 1 for which the component temporary pressure bonding process 5200 shown in FIG. 2 has been performed. For the description, FIG. 8 shows a flow chart showing the procedures of the final pressure bonding operations, FIGS. 9A and 9B show schematic illustrations showing status in which the final pressure bonding operation is performed for the long side terminal portion 2A of the panel substrate 1, and FIGS. 10A and 10B show schematic illustrations showing status in which the final pressure bonding operation is performed for the short side terminal portion 2B. FIGS. 11A, 11B, 11C, and 11D show schematic diagrams showing contact positions of the pressure bonding heads 31 on the protection sheet 5 in the final pressure bonding operations. The procedures of the final pressure bonding operations that will be described below are performed with control over operations of the component units by the control device 19 the final pressure-bonding apparatus 100 includes.

In a step S1 in the flow chart of FIG. 8, the panel substrate 1 is carried into the final pressure-bonding apparatus 100. As shown in FIG. 3, specifically, the panel substrate 1 having the plurality of TCPs 4 temporarily press-bonded thereon is conveyed in the X-axis direction by the moving device 23 while being held by the panel holding unit 21, and is carried in by being placed on the stage 11.

Subsequently, information (component pressure bonding position information) on positions where the TCPs 4 are press-bonded on the long side terminal portion 2A of the panel substrate 1 carried into the final pressure-bonding apparatus 100 is acquired by the control device 19 (step S2). Examples of the component pressure bonding position information are information that the three TCPs 4 are temporarily press-bonded on the long side terminal portion 2A with an interval pitch P1, as shown in the schematic illustration of FIG. 9B, and relative positional information on temporary pressure-bonding positions of the TCPs 4 on the long side terminal portion 2A of the panel substrate 1. The component pressure bonding position information may include information on a type of the TCPs 4, a heating temperature and a pressure for the thermal pressure bonding, and/or the like. Such information may be stored in the control device 19 in advance and may be read from storage units or the like on basis of information on production of the panel substrate 1, instead of being acquired upon the carrying-in of the panel substrate 1. Such information may be acquired with the carrying-in of the panel substrate 1 and at least has only to be acquired by the time the subsequent steps S3 and S4 are performed. The acquisition of the component pressure bonding position information in the step S2 may be carried out in advance before the carrying-in of the panel substrate in the step S1.

Subsequently, it is determined whether adjustment of arrangement of the three pressure bonding units 10 the final pressure-bonding apparatus 100 has is required or not, on basis of the component pressure bonding position information on the long side terminal portion 2A of the panel substrate 1 which information has been acquired by the control device 19 (step S3). If it is determined that the adjustment of the arrangement is required, the pressure bonding units 10 are moved independently of one another along the X-axis direction while being guided by the LM guides 35 by the actuation of the unit moving motors 36 the pressure bonding units 10 have. Positions and intervals of the arrangement of the three pressure bonding units 10 are individually adjusted by the actuation of the respective unit moving motors 36 on basis of the interval pitch P1 of the pressure bonding positions and the positional information of the TCPs 4 which information is included in the component pressure bonding position information (step S4). Such movement of the pressure bonding units 10 is carried out in a state in which the restricting member 43 is spaced apart from the levers 38 (in a state in which the restricting member 43 is in the shelter position). After that, the long side terminal portion 2A of the panel substrate 1 is placed on the backup stages 32 of which positioning relative to the pressure bonding positions has been attained. In a state in which the placement is attained, the pressure bonding positions (i.e., the long side terminal portion 2A) are located along the X-axis direction so as to correspond to the arrangement of the pressure bonding units 10.

In parallel with processing operations in the steps S3 and S4, on the other hand, it is determined whether the feeding supply of the protection sheet 5 suspended between the pressure bonding heads 31 and the backup stages 32 under tension is required or not (step S5). If the protection sheet 5 stretched under tension in a position between the pressure bonding heads 31 and the backup stages 32 has been spent or if the sheet is not suspended under tension in the position, for instance, the operation of feeding the protection sheet 5 along the conveying path is performed by the protection sheet supplying device 50 so that a fresh portion of the protection sheet 5 is supplied and placed between the pressure bonding heads 31 and the backup stages 32 (step S6). The adjustment of the arrangement of the pressure bonding units 10 in the step S4 and the operation of the feeding supply of the protection sheet 5 in the step S6 can simultaneously be performed.

After that, the final pressure bonding operation for the TCPs 4 on the long side terminal portion 2A is performed by the pressure bonding units 10 of which the positioning has been attained (step S7). As shown in FIG. 9A, specifically, the two suspending rollers 57 and 61 of the protection sheet supplying device 50 are lowered by the up-and-down units 58 and 62, so that the protection sheet 5 is placed on the pressure bonding positions of the three TCPs 4 temporarily press-bonded on the long side terminal portion 2A of the panel substrate 1. By the performance of the pivotal motions of the levers 38 with the restriction on the levers 38 by the pressure applying units 37 and the head motion restricting device 42, subsequently, the pressure bonding heads 31 are lowered and the pressing surfaces (pressure bonding surfaces) that are bottom surfaces of the pressure bonding heads 31 are brought into contact with the TCPs 4 through the protection sheet 5. By the application of the specified pressures onto the TCPs 4 by the pressure applying units 37, furthermore, the final pressure bonding and mounting of the three TCPs 4 through the ACF sheets 3 are attained on the three component pressure bonding positions on the long side terminal portion 2A of the panel substrate 1.

The schematic diagram of FIG. 11A shows a relation of arrangement in plan between the pressing positions (contact positions) of the pressure bonding heads on the three TCPs 4 placed on the long side terminal portion 2A of the panel substrate 1 and the protection sheet 5. In a description below, a rightward direction in the X-axis direction will be referred to as an X-axis plus direction, a leftward direction in the same will be referred to as an X-axis minus direction, a frontward direction in the Y-axis direction will be referred to as a Y-axis plus direction, and a backward direction in the same will be referred to as a Y-axis minus direction, in view from a position of an operator, as shown in FIG. 11A. As shown in FIG. 11A, the protection sheet 5 is in a state in which the sheet has been moved in the Y-axis minus direction by the Y-axis direction sheet moving device 70, and the pressing surfaces of the pressure bonding heads 31 are in contact with an area of the protection sheet 5 on right side (the Y-axis plus side) with respect to the direction of the width of the protection sheet 5 (area on front side as for the operator), as seen looking in the X-axis feeding direction (X-axis plus direction) for the protection sheet 5. Positions (areas) shown with hatching on a surface of the protection sheet 5 in FIG. 11A are contact positions CP1 of the pressing surfaces (pressure bonding surfaces) of the pressure bonding heads 31 on the protection sheet 5 used in the final pressure bonding operation on the long side terminal portion 2A. A position to which the protection sheet 5 has been moved in the Y-axis direction in such a state will be referred to as “Y-axis direction right area using position” (using position on right side (Y-axis plus side) in the drawing in the Y-axis direction) for clarity of description that will be given later. A reference position R shown by a center line in FIG. 11A is a reference position for facilitating comparison among moved positions of the pressure bonding heads 31 in the X-axis direction in FIGS. 11A through 11D and shows a center position of arrangement of the three pressure bonding heads 31 used in the state shown in FIG. 11A.

Positional information on the contact positions CP1 of the pressure bonding heads 31 on the protection sheet 5 is stored as NC data, for instance, in the storage units of the control device 19. Positioning between the protection sheet 5 and the pressure bonding heads 31 can be performed with reference to the positional information stored in the storage units of the control device 19 so as not to bring the pressure bonding heads 31 again into contact with the contact positions that have already been used, for instance, in the later final pressure bonding operations.

Once the final pressure bonding operation for the long side terminal portion 2A of the panel substrate 1 is thus completed, component pressure bonding position information on the short side terminal portion 2B of the panel substrate 1 is acquired by the control device 19 (step S8). Specifically, information that two TCPs 4 have been temporarily press-bonded on the short side terminal portion 2B with an interval pitch P2, as shown in the schematic illustration of FIG. 10B, or the like is acquired. Such information may be acquired in advance together with the information on the long side terminal portion 2A in step S2, before or after the carrying-in of the panel substrate in step S1.

Subsequently, the panel substrate 1 is moved by the panel substrate holding device 12 so as to be spaced apart from the backup stages 32, and a θ-turn of the held panel substrate 1 in the X-Y plane is carried out, so that the panel substrate 1 has a posture with the short side terminal portion 2B of the panel substrate 1 extending along the X-axis direction (step S9).

With an operation of step S9, it is determined whether adjustment of the arrangement of the three pressure bonding units 10 the final pressure-bonding apparatus 100 has is required or not, on basis of the component pressure bonding position information on the short side terminal portion 2B of the panel substrate 1 which information has been acquired by the control device 19 (step S10). If it is determined that the adjustment of the arrangement is required, the adjustment of the arrangement of the pressure bonding units 10 is carried out in accordance with the same procedures as those in the step S4 described above (step S11). Specifically, two out of the three pressure bonding units 10 are selected and used because only two TCPs 4 have been temporarily press-bonded on the short side terminal portion 2B. In this case, the pressure bonding unit 10 positioned at a right end along the X-axis direction in the drawing is moved to a shelter position in which interference thereof with the panel substrate 1 is prevented, as shown in FIG. 10A.

Upon completion of the adjustment of the arrangement of the pressure bonding units 10, the panel substrate 1 is moved by the panel substrate holding device and the short side terminal portion 2B of the panel substrate 1 is placed so that positioning of two component pressure bonding positions on the backup stages 32 of the selected two pressure bonding units 10 is attained.

With this operation, the protection sheet 5 stretched under tension by the protection sheet supplying device 50 is moved in the Y-axis plus direction so that an area of the protection sheet 5 on left side as seen looking in the X-axis feeding direction is positioned immediately under the pressure bonding heads 31. Specifically, the protection sheet supplying device 50 in the Y-axis direction right area using position is moved by the Y-axis direction sheet moving device 70 in the Y-axis plus direction with respect to the pressing positions (contact positions) of the pressure bonding heads 31, so that the left-side area of the protection sheet (area that has not been used with respect to the Y-axis direction in the drawing, i.e., the direction of the width thereof) is positioned immediately under the pressure bonding heads 31, and the contact positions of the pressing surfaces of the pressure bonding heads 31 on the protection sheet 5 are changed in the direction of the width of the protection sheet 5 (the Y-axis direction in the drawing) (step S12). Herein, the position to which the protection sheet 5 has been moved in the Y-axis direction in such a state is referred to as “Y-axis direction left area using position” (position with use of left side (Y-axis minus side) in the drawing in the Y-axis direction). When an operation of changing the contact positions of the pressing surfaces of the pressure bonding heads 31 on the protection sheet 5 is performed, an operation of the protection sheet supplying device 50 or the Y-axis direction sheet moving device 70 is controlled with reference to the positional information on the contact positions in the past that has been stored in the storage units of the control device 19. The θ-turn of the panel substrate 1 in the step S9, the adjustment of the arrangement of the pressure bonding units 10 in the step S11, and the operation of changing the contact positions on the protection sheet 5 in the direction of the width in the step S12 can be performed with the same timing.

After that, the final pressure bonding operation for the TCPs 4 on the short side terminal portion 2B is performed by the two pressure bonding units 10 of which the positioning has been attained (step S13). As shown in FIG. 10A, specifically, the two suspending rollers 57 and 61 of the protection sheet supplying device 50 are lowered by the up-and-down units 58 and 62, so that the protection sheet 5 is placed on the pressure bonding positions of the two TCPs temporarily press-bonded on the short side terminal portion 2B of the panel substrate 1. By the performance of the pivotal motions of the levers 38 with the restriction on the levers 38 by the pressure applying units 37 and the head motion restricting device 42, subsequently, the pressure bonding heads 31 are lowered and the pressing surfaces (pressure bonding surfaces) that are the bottom surfaces of the pressure bonding heads 31 are brought into contact with the TCPs 4 through the protection sheet 5. By application of specified pressures onto the TCPs 4 by the pressure applying units 37, furthermore, the final pressure bonding and mounting of the two TCPs 4 through the ACF sheets 3 are attained on the two component pressure bonding positions on the short side terminal portion 2B of the panel substrate 1.

Upon completion of the final pressure bonding operation for the TCPs 4 on the short side terminal portion 2B of the panel substrate 1, the panel substrate 1 is moved by the panel substrate holding device 12 so as to be spaced apart from the backup stages 32, and the panel substrate 1 mounted with the TCPs 4 is carried out of the final pressure-bonding apparatus 100 (step S14).

The schematic diagram of FIG. 11B shows a relation of arrangement in plan between pressing positions of the pressure bonding heads 31 on the two TCPs 4 placed on the short side terminal portion 2B of the panel substrate 1 and the protection sheet 5. Contact positions shown by dotted lines on the protection sheet 5 in FIG. 11B show the contact positions CP1 that have been used in the precedent final pressure bonding operation on the long side terminal portion 2A. Contact positions shown by solid lines on the protection sheet 5 in FIG. 11B show contact positions CP2 that have been used in the final pressure bonding operation performed on the short side terminal portion 2B in the step S13. As shown in FIG. 11B, the protection sheet 5 is in a state in which the sheet has been moved in the Y-axis plus direction with respect to the pressing positions (contact positions) of the pressure bonding heads 31 by the Y-axis direction sheet moving device 70, and the pressing surfaces of the pressure bonding heads 31 are in contact with the area of the protection sheet 5 on left side with respect to the Y-axis direction, that is, the direction of the width of the protection sheet 5 (Y-axis direction left-side area in the drawing), as seen looking in the X-axis feeding direction (X-axis plus direction) for the protection sheet 5. That is, the final pressure bonding operation for the TCPs 4 on the short side terminal portion 2B is performed in the state in which the protection sheet supplying device 50 has been moved by the Y-axis direction sheet moving device 70 from the Y-axis direction right area using position to the Y-axis direction left area using position so that the contact positions (pressing positions) of the pressure bonding heads 31 on the protection sheet 5 have been changed in the direction of the width of the protection sheet 5. Positional information on the contact positions CP2 of the pressure bonding heads 31 on the protection sheet 5 is stored in the storage units of the control device 19.

By such movement of the protection sheet 5 in the direction of the width, unused areas on the protection sheet 5 with respect to the direction of the width (Y-axis direction) can efficiently be used so that an efficiency of use of the protection sheet 5 can be increased. In particular, the movement of the protection sheet 5 in the direction of the width can be attained within a short distance and in a short period of time, in comparison with use of unused areas on the protection sheet 5 with respect to a longitudinal direction thereof with movement of the protection sheet 5 in the X-axis direction that is the longitudinal direction. This shortens time required for the operation of changing the contact positions of the pressure bonding heads 31 on the protection sheet 5 and permits achievement of efficient final pressure bonding operations in the final pressure-bonding apparatus 100.

Between the arrangement of mounting positions of the TCPs 4 on the long side terminal portion 2A of the panel substrate 1 and the arrangement of mounting positions of the TCPs 4 on the short side terminal portion 2B, not only the pitches P1, P2 of the arrangement may differ but also numbers of the TCPs 4 may often differ, as apparent from FIGS. 9B, 10B, 11A, and 11B. Even in such a case, influence of the difference in the pitch of the arrangement and the like is prevented by the operation of changing the contact positions in the direction of the width of the protection sheet 5. As a result, various arrangements of the mounting positions of the TCPs 4 can be addressed and efficient final pressure bonding operations can be achieved.

In the flow chart of FIG. 8, the final pressure bonding operations for one panel substrate 1 are completed by an operation of carrying out the panel substrate 1 in the step S14. When the final pressure bonding operations are thereafter performed for another panel substrate 1 carried into the final pressure-bonding apparatus 100, the procedures from the step S1 to the step S14 are sequentially performed. Contact positions of the pressure bonding heads 31 on the protection sheet 5 used in the final pressure bonding operations for another panel substrate 1 will be described with reference to the schematic plan views of FIGS. 11C and 11D. The panel substrate 1 for which the final pressure bonding processing has earlier been performed and another panel substrate 1 have the same specifications.

FIG. 11C is the diagram showing contact positions CP3 on the protection sheet 5 that are used in the final pressure bonding operation on a long side terminal portion 2A of said another panel substrate 1. As shown in FIG. 11C, the contact positions CP3 on the protection sheet 5 that are used in the final pressure bonding operation on the long side terminal portion 2A of said another panel substrate 1 are arranged in areas (areas with respect to the X-axis direction) between the contact positions CP1 on the protection sheet 5 that were used in the final pressure bonding operation on the long side terminal portion 2A of the panel substrate 1 for which the final pressure bonding operations were earlier performed.

Specifically, it is determined by the control device 19 whether the contact positions CP3 can be arranged or not in the areas between the contact positions CP1, with reference to the information on the arrangement of the contact positions that has been stored in the storage units of the control device 19. If it is determined that the arrangement can be attained, the pressure bonding units 10 are moved independently of one another along the X-axis direction while being guided by the LM guides 35 by the actuation of the respective unit moving motors 36 of the pressure bonding units 10, the protection sheet supplying device 50 is moved in the Y-axis direction by the Y-axis direction sheet moving device 70, and relative positioning between the pressure bonding heads 31 and the protection sheet 5 is thereby attained so that the pressure bonding heads 31 and the protection sheet 5 can be brought into contact with each other in the areas between the contact positions CP1. As a result, the contact positions CP3 can be arranged between the contact positions CP1 on the protection sheet 5 that were used in the preceding final pressure bonding operation on the long side terminal portion 2A, as shown in FIG. 11C, so that the efficiency of the use of the protection sheet 5 can further be increased. The arrangement of the contact positions CP3 on the protection sheet 5 that are used in the final pressure bonding operation on the long side terminal portion 2A of said another panel substrate 1 can be attained also by movement of the protection sheet, caused by the protection sheet supplying device 50, by a distance not less than a length of the pressing surfaces of the pressure bonding tools 31a of the pressure bonding heads 31 as the pressing members and by resultant change in the contact positions of the pressing members on the protection sheet 5 in the first direction (X-axis direction). The change in the positions by the movement of the protection sheet 5 in the X-direction allows the pressure bonding operation without change in a position of the long side terminal portion 2A of said another panel substrate 1, relative to a position of the long side terminal portion 2A of the former panel substrate 1, together with the positions of the pressure bonding heads 31 (the contact positions along the longitudinal direction (X-axis direction) of the protection sheet 5).

When the final pressure bonding operation is thereafter performed on a short side terminal portion 2B of said another panel substrate 1, as shown in FIG. 11D, contact positions CP4 on the protection sheet 5 can be arranged between the contact positions CP2 that were used in the final pressure bonding operation on the short side terminal portion 2B of the former panel substrate 1. Specifically, positioning of two out of the three pressure bonding heads 31 is performed so as to correspond to the pressing positions of the TCPs 4, the protection sheet 5 is moved in the Y-axis direction by the Y-axis direction sheet moving device 70, and positioning between the pressure bonding heads 31 and the protection sheet 5 is thereby attained so that the pressure bonding heads 31 can be brought into contact with between the contact positions CP2 on the protection sheet 5. When the final pressure bonding operation is performed on the short side terminal portion 2B of said another panel substrate 1, relative positioning between the pressure bonding heads 31 and the protection sheet 5 is attained with reference to the information on the arrangement of the contact positions in the past that has been stored in the storage units of the control device 19.

Thus the areas on the protection sheet 5 between the contact positions CP1 and CP2 that were used in the preceding final pressure bonding operations are used in the next final pressure bonding operations, so that the efficiency of the use of the protection sheet 5 can further be increased. In particular, the operations of changing the contact positions can efficiently be performed by the change in the contact positions on the protection sheet 5 in the direction of the width of the protection sheet 5 for the final pressure bonding operation with a different arrangement of the pressure bonding heads 31 and by the change in the contact positions on the protection sheet 5 in the longitudinal direction of the protection sheet 5 and the use of the areas between the former contact positions for the final pressure bonding operation with the same arrangement.

When the final pressure bonding operations for another panel substrate 1 are performed, the pressure bonding heads 31 are moved in the X-axis leftward direction and the movement may be attained by either the movement of the pressure bonding heads 31 or the movement of the protection sheet 5 by the feeding operation, or by combination of both. As will be described later, a device for moving the suspended protection sheet 5 in the X-axis direction may be provided, and the relative movement between the pressure bonding heads 31 and the protection sheet 5 may be performed by movement of the suspended protection sheet 5 in the X-axis direction.

Though the pressure bonding apparatus that is the final pressure-bonding apparatus 100 for performing the final pressure bonding operations for TCPs as objects has been described as an example for the first embodiment, other apparatuses in such outer lead bonding processes can be used as an example of the pressure bonding apparatus. For instance, a temporary pressure-bonding apparatus for performing the component temporary pressure bonding process S200 for TCPs 4 as objects can be used as an example of the pressure bonding apparatus. An ACF applying apparatus for performing the ACF applying process 5100 for the ACF sheets 3, which are joining sheets, as objects can be used as an example of the pressure bonding apparatus.

Though the final pressure bonding processing for the only three TCPs 4 on the long side terminal portion 2A of the panel substrate 1 has been described for the example, the pressure bonding method of the first embodiment can be applied to an example in which the final pressure bonding operation is performed for more TCPs 4 arranged (temporarily press-bonded) on the long side terminal portion 2A. In an example in which twelve TCPs 4 have been temporarily press-bonded with the interval pitch P1 on the long side terminal portion 2A of the panel substrate 1, for instance, the final pressure bonding of the TCPs 4 on the terminal portion 2A can be attained by four times repetition of the final pressure bonding operation by the three pressure bonding heads 31.

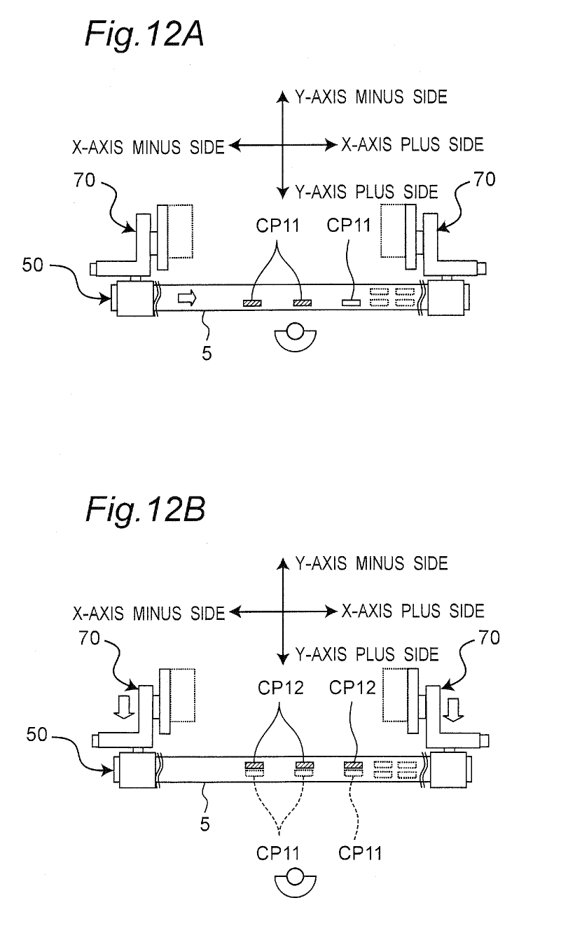

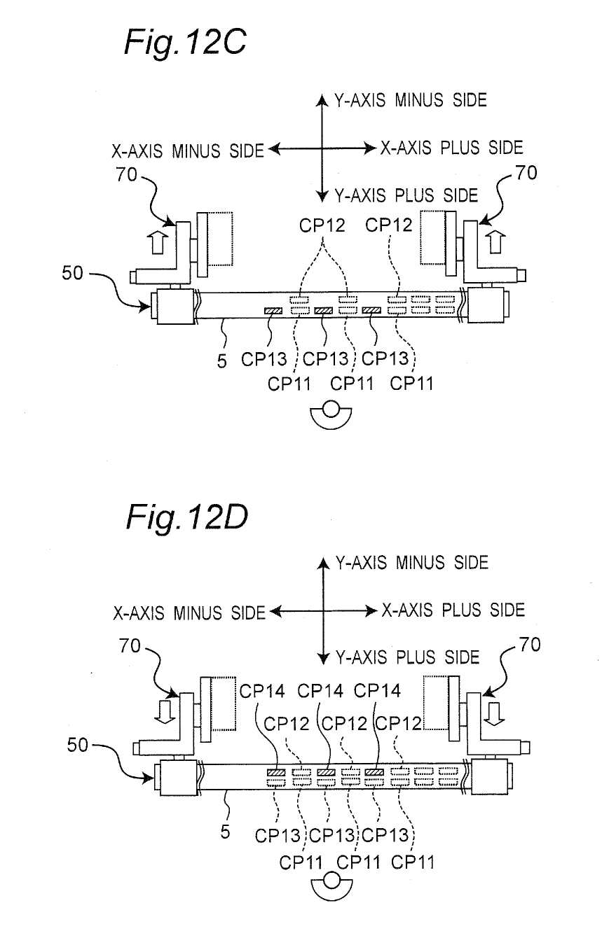

FIGS. 12A through 12D show schematic illustrations for an example in which the final pressure bonding operation is repeated in such a manner. As shown in FIG. 12A, initially, the final pressure bonding operation for the three TCPs 4 is performed, by the three pressure bonding heads 31 positioned with the interval pitch P1, through the protection sheet 5 positioned in the Y-axis direction right area using position. Contact positions that are used in the final pressure bonding operation are shown as contact positions CP11 in FIG. 12A.

As shown in FIG. 12B, after that, the protection sheet 5 is positioned in the Y-axis direction left area using position by the Y-axis direction sheet moving device 70, and the final pressure bonding operation for the next three TCPs 4 is performed. Contact positions that are used in the second final pressure bonding operation are shown as contact positions CP12 in FIG. 12B.

As shown in FIG. 12C, after that, relative movement of the pressure bonding heads 31 in the X-axis direction with respect to the panel substrate 1 is carried out, positioning of the protection sheet 5 into the Y-axis direction right area using position is performed by the Y-axis direction sheet moving device 70, and thus positioning of the three pressure bonding heads 31 on the protection sheet 5 is performed so that the three pressure bonding heads 31 can be brought into contact with areas between the contact positions CP11 on the protection sheet 5. In a state in which the positioning has been attained, the final pressure bonding operation for the next three TCPs 4 is performed. Contact positions CP13 that are used in the third final pressure bonding operation are arranged between the contact positions CP11.

As shown in FIG. 12D, after that, the protection sheet 5 is positioned in the Y-axis direction left area using position by the Y-axis direction sheet moving device 70, and the final pressure bonding operation for the next three TCPs 4 is performed. Contact positions CP14 that are used in the fourth final pressure bonding operation are arranged between the contact positions CP12.

On condition that the final pressure bonding operation is thus repeated a plurality of times with the plurality of pressure bonding heads 31 having the same arrangement, the efficiency of use of the protection sheet can be increased and efficient final pressure bonding operations can be achieved by combination of the movement of the protection sheet 5 in the direction of the width and the movement of thereof in the longitudinal direction.

Though the example in which the twelve TCPs 4 are arranged with the same interval pitch P1 on the long side terminal portion 2A of the panel substrate 1 has been described as the example shown in FIGS. 12A through 12D, such a pressure bonding method can be applied to an example in which TCPs 4 at least more than the provided pressure bonding heads 31 are arranged at uniform intervals. The method can be applied to an example in which TCPs 4 are arranged with the same interval pitch on the long side terminal portion 2A and the short side terminal portion 2B.

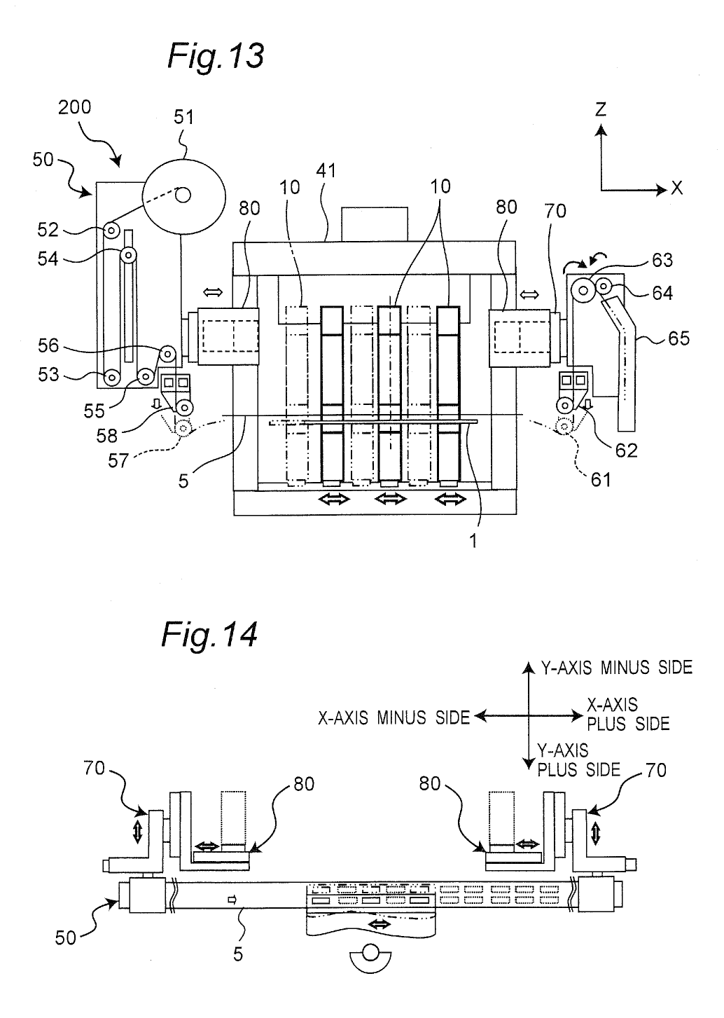

FIGS. 13 and 14 show a schematic front view and a schematic fragmentary plan view diagram showing a partial configuration of a final pressure-bonding apparatus 200 in accordance with a modification of the first embodiment.

As shown in FIGS. 13 and 14, the final pressure-bonding apparatus 200 in accordance with the modification has a configuration different from that of the final pressure-bonding apparatus 100 in that an X-axis direction sheet moving device 80 for causing advance and reverse movement of the protection sheet supplying device 50 as a whole along the X-axis direction is provided therein. Other configurations of the final pressure-bonding apparatus 200 are the same as those of the final pressure-bonding apparatus 100, the same component parts are therefore designated by the same reference characters, and description thereof is omitted.

As shown in FIGS. 13 and 14, the final pressure-bonding apparatus 200 has the Y-axis direction sheet moving device 70 for causing advance and reverse movement of the protection sheet supplying device 50 as a whole in the Y-axis direction, i.e., the direction of the width of the protection sheet 5 and the X-axis direction sheet moving device 80 for causing advance and reverse movement of the protection sheet supplying device 50 as a whole in the X-axis direction, i.e., the longitudinal direction of the protection sheet 5. Thus advance and reverse movement of the protection sheet 5 can be caused not only in the direction of the width but also in the longitudinal direction relative to the pressure bonding units 10. When the contact positions with respect to the pressure bonding heads 31 are required to be changed in the longitudinal direction of the protection sheet 5, for instance, consequently, an operation of changing the contact positions in the longitudinal direction can be performed without the operation of feeding the suspended protection sheet 5, for instance, by movement of the protection sheet supplying device 50 in the X-axis direction by the X-axis direction sheet moving device 80 without movement of the pressure bonding heads 31. When the final pressure bonding operation is repeated with the plurality of pressure bonding heads 31 held in the same arrangement without change therein, particularly, the relative positioning between the pressure bonding heads 31 and the protection sheet 5 can be attained by movement of the protection sheet in the X-axis direction by the X-axis direction sheet moving device 80 without movement of the pressure bonding heads 31, and thus efficient operations can be performed.

When the protection sheet 5 is required to be moved in the X-axis direction leftward in the drawing in FIGS. 13 and 14, the protection sheet 5 can be moved by movement of the protection sheet supplying device 50 as a whole in the X-axis direction leftward in the drawing by the X-axis direction sheet moving device 80 without rewinding of the protection sheet 5, which has been fed once, by reverse rotation of the supply reel 51 in the protection sheet supplying device 50. This reliably prevents the spent protection sheet 5 from contaminating driving parts (such as rollers) of the protection sheet supplying device 50. The movement and feeding of the protection sheet 5 by the protection sheet supplying device 50 is not limited to those in a state in which the sheet is suspended but the protection sheet 5 may be moved and fed in a state in which a little looseness exists (unsuspended state), that is, in a state in which the sheet is only placed without being suspended.

### Second Embodiment

Subsequently, a pressure bonding method in accordance with a second embodiment of the invention will be described. The pressure bonding method of the second embodiment has a characteristic on control in that a requirement from an operator or the like of priority of tact time for the final pressure bonding operations or a requirement from the operator or the like of priority of the efficiency of use of the protection sheet can selectively be satisfied with use of the final pressure-bonding apparatus 100 of the first embodiment. The pressure bonding method of the second embodiment will be described below specifically.

Herein, the operations of moving the protection sheet 5 in the final pressure-bonding apparatus 100 will be clarified for description of the pressure bonding method of the second embodiment. The change in the contact positions of the pressure bonding heads 31 on the protection sheet 5 by movement of the protection sheet 5 in the Y-axis direction, i.e., the direction of the width by the Y-axis direction sheet moving device 70 will be referred to as “contact position change by Y-axis direction movement.” The change in the contact positions by relative movement between the pressure bonding heads 31 and the protection sheet 5 in the X-axis direction, i.e., the longitudinal direction for purpose of using areas between previously used contact positions as next contact positions will be referred to as “contact position change by X-axis direction short feeding operation.” The change in the contact positions by relative movement between the pressure bonding heads 31 and the protection sheet 5 in the X-axis direction for purpose of using areas, which have not been used with respect to the direction of the width also, as next contact positions will be referred to as “contact position change by X-axis direction long feeding operation.” In the contact position change by X-axis direction long feeding operation, an operation of changing the contact positions is performed by a relative feeding operation for the protection sheet 5 in the X-axis direction so that areas having no spent contact positions are used for next contact positions. According to the pressure bonding method of the second embodiment, the pressure bonding method is thus provided in which requirements from an operator or the like can be satisfied by selective use of the three types of the contact position change.

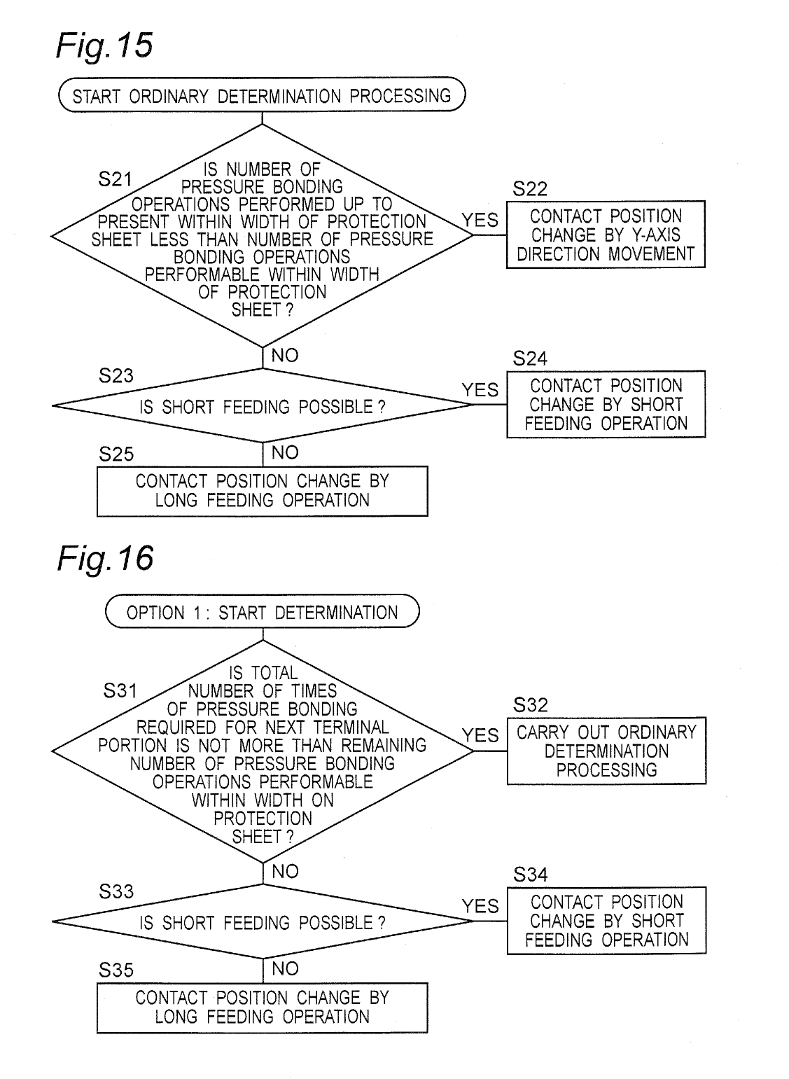

FIG. 15 shows a flow chart of procedures of ordinary determination processing that is ordinarily used for determining which changing operation is to be applied out of the three types of contact position changing operation in the pressure bonding method of the second embodiment. The ordinary determination processing is a control mode that is applied with priority of increase in the efficiency of use of the protection sheet 5. That is, the ordinary determination processing is applied, to the final pressure-bonding apparatus 100, as a standard control mode that is a protection sheet using efficiency priority mode in which priority is given to use of more contact positions in an area on the protection sheet 5. Instead of being applied as the standard control mode, however, the processing may selectively be applied by an operator or the like.

In the final pressure-bonding apparatus 100, the ordinary determination processing shown in FIG. 15 is started in the control device 19 before the individual final pressure bonding operation for the terminal portion 2A of the panel substrate 1 is started. In step S21, initially, it is determined whether a number of the pressure bonding operations that have already been performed with respect to the direction of the width of the protection sheet 5 at present (that is, a number of spent contact positions along the direction of the width) is less than a number of pressure bonding operations that can be performed on the protection sheet 5 with respect to the direction of the width (that is, a maximum number of contact positions that can be arranged or a maximum possible number of times of the change of the contact positions along the direction of the width). The determination is carried out on basis of a relative positional relation between the pressure bonding heads 31 and the protection sheet 5 in a state in which positioning between the pressure bonding heads 31 and the pressure bonding positions on the panel substrate 1 has been attained. The positioning is not required to be actually completed, and the determination is carried out by the control device 19 on assumption of such a positional relation for the control and with reference to the information on arrangement of the contact positions in the past that has been stored in the storage units of the control device 19 (information on number of times and positions of pressure bonding) and specifications (such as width) of the protection sheet 5. When the protection sheet 5 is in a state shown in a schematic diagram of FIG. 18, for instance, the number of the pressure bonding operations that have already been performed within the width on the protection sheet 5 at present is two and the number of the pressure bonding operations that can be performed within the width on the protection sheet 5 is four, and thus it is determined that the number of the pressure bonding operations that have already been performed within the width on the protection sheet 5 at present is less than the number of the pressure bonding operations that can be performed within the width on the protection sheet 5. In the drawing, reference characters CP denote contact positions, contact positions CP that have already been used are hatched, and unused contact positions CP are shown by dashed lines.

If it is determined in the step S21 that the number of the pressure bonding operations that have already been performed within the width on the protection sheet at present is less than the number of the pressure bonding operations that can be performed within the width on the protection sheet 5 (i.e., in the state shown in FIG. 18), the contact position changing operation by Y-axis direction movement is performed (step S22) because the contact positions can be ensured by movement of the protection sheet 5 in the Y-axis direction in the positional relation in which the positioning has been attained.

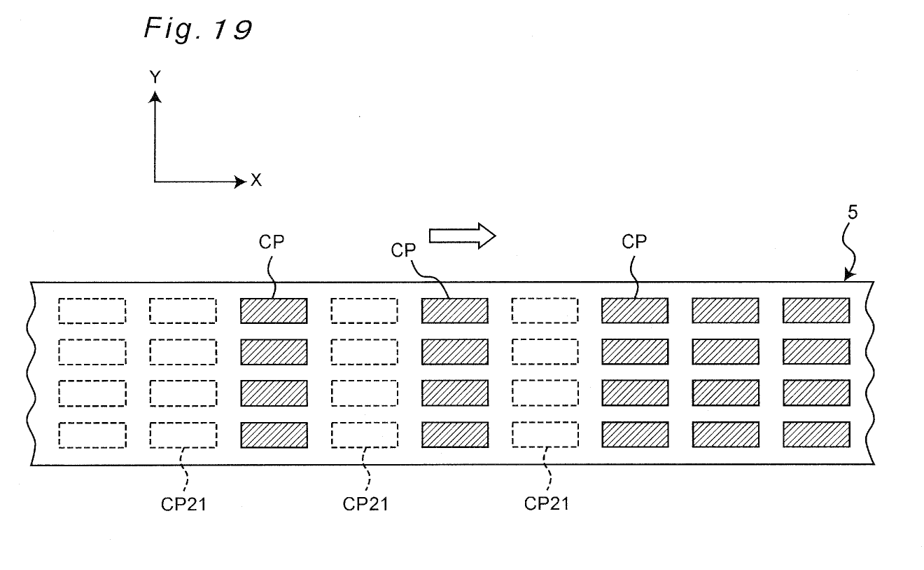

If it is determined in the step S21 that the number of the pressure bonding operations that have already been performed within the width on the protection sheet at present has reached the number of the pressure bonding operations that can be performed within the width on the protection sheet 5 (e.g., in a state of the protection sheet 5 as shown in FIG. 19 in which the number of the pressure bonding operations that can be performed within the width has reached four), it is determined whether the short feeding operation for the protection sheet 5 is possible or not (step S23).

If it is determined that the short feeding operation is possible, the contact position change by the short feeding operation for the protection sheet 5 is performed (step S24). Specifically, the short feeding operation for the protection sheet 5 is performed in order that contact positions CP21 on the protection sheet 5 in FIG. 19 may be used as next contact positions.

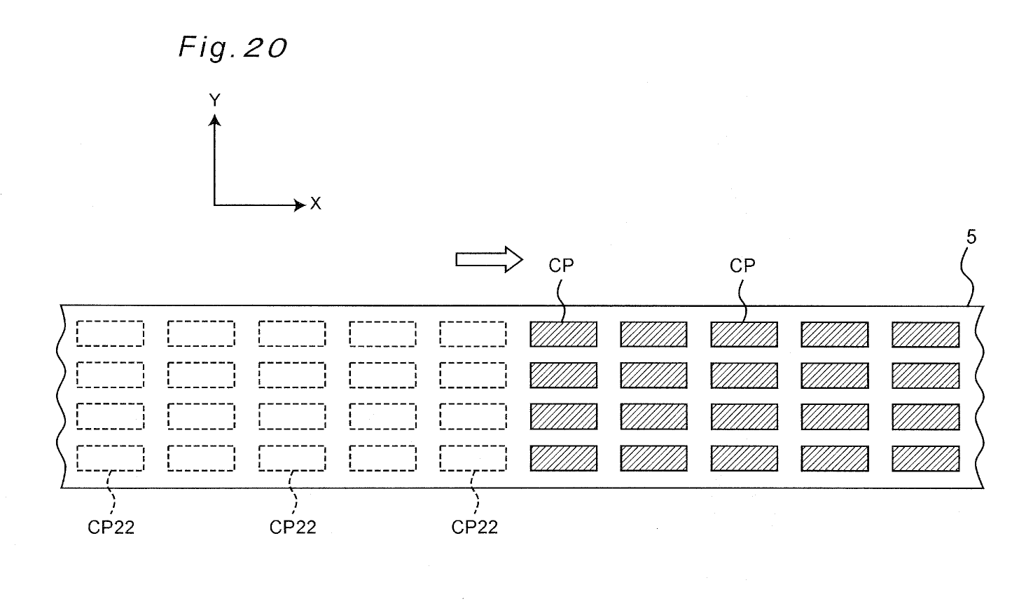

If it is determined in the step S23 that the short feeding operation is impossible, the contact position change by the long feeding operation for the protection sheet 5 is performed (step S25). Specifically, the long feeding operation for the protection sheet 5 is performed in order that contact positions CP22 on the protection sheet 5 in FIG. 20 may be used as next contact positions.

After that, the final pressure bonding operation is performed with use of the pressure bonding heads 31. Once the final pressure bonding operation is completed, the ordinary determination processing is started immediately after the completion or when the next final pressure bonding operation is started.

In the ordinary determination processing in which priority is given to the contact position changing operation by Y-axis direction movement followed by the contact position changing operation by the short feeding operation and the contact position changing operation by the long feeding operation, vacant areas on the protection sheet 5 can efficiently be used so that the efficiency of use of the protection sheet 5 can be increased.

FIG. 16 shows a flow chart of procedures of determination processing of an option 1 that is selectively used instead of the ordinary determination processing. The determination processing of the option 1 is a control mode that is applied with priority of decrease in time required for the final pressure bonding operation, and is prepared as a final pressure bonding operation tact priority mode that is a selectable control option for the final pressure-bonding apparatus 100. The determination processing of the option 1 is selectably applied when the final pressure bonding operation for the terminal portion 2 as a whole on one side of the panel substrate 1 is started (in particular, when the panel is carried in or out, when the panel is turned for switching to another side of the panel, or the like).

In a step S31 of FIG. 16, initially, it is determined whether a total number of times of pressure bonding required for the final pressure bonding operations to be started for a next terminal portion 2 as a whole (total number of a plurality of pressure bonding operations, if required) is not more than a number of remaining pressure bonding operations that can be performed widthwise on the protection sheet 5. The determination is carried out on basis of the relative positional relation between the pressure bonding heads 31 and the protection sheet 5 in a state in which the positioning between the pressure bonding heads 31 and the pressure bonding positions on the panel substrate 1 has been attained or in a state before performance of the positioning. The positioning is not required to be actually completed, and the determination is carried out by the control device 19 on assumption of such a positional relation for the control and with reference to the information on arrangement of the contact positions that has been stored in the control device 19, or the like.

If it is determined in the step S31 that the total number of times of pressure bonding required for the final pressure bonding operations to be started for the next terminal portion 2 as a whole is not more than the number of times of remaining pressure bonding operations that can be performed widthwise on the protection sheet 5, the ordinary determination processing shown in FIG. 15 is carried out (step S32). On condition that the total number of times of pressure bonding required for the final pressure bonding operations to be started for the next terminal portion 2 as a whole is two and that the protection sheet 5 is in such a state as shown in FIG. 18, for instance, it is determined that the total number of times of pressure bonding required for the final pressure bonding operations for the next terminal portion 2 as a whole is not more than the number of times of remaining pressure bonding operations that can be performed widthwise on the protection sheet 5.

If it is determined in the step S31 that the total number of times of pressure bonding required for the final pressure bonding operations to be started for the next terminal portion 2 as a whole exceeds the number of times of remaining pressure bonding operations that can be performed widthwise on the protection sheet 5, it is subsequently determined whether the short feeding operation for the protection sheet 5 is possible or not (step S33). If it is determined that the short feeding operation is possible, the contact position change by the short feeding operation for the protection sheet 5 is performed (step S34). On condition that the total number of times of pressure bonding required for the final pressure bonding operations to be started for the next terminal portion 2 as a whole is three and that the protection sheet 5 is in such a state as shown in FIG. 18, for instance, the contact position change by the short feeding operation for the protection sheet 5 is performed. If it is determined in the step S33 that the short feeding operation is impossible (if the protection sheet 5 is in such a state as shown in FIG. 20, for instance), the contact position change by the long feeding operation for the protection sheet 5 is performed (step S35). After that, the final pressure bonding operation for the terminal portion 2 on the one side is performed with use of the pressure bonding heads 31.

In the determination processing of the option 1, in principle, the contact position changing operations by X-axis direction movement, i.e., the contact position changing operations by the short feeding operation and the long feeding operation are applied by priority over the contact position changing operation by Y-axis direction movement. The ordinary determination processing is carried out, however, if the total number of times of pressure bonding required for the final pressure bonding operations to be started for the next terminal portion 2 as a whole is not more than the number of times of remaining pressure bonding operations that can be performed widthwise on the protection sheet 5, that is, if the movement of the protection sheet 5 in the X-axis direction is not required for ensuring the total number of times of pressure bonding required for the final pressure bonding operations for the terminal portion 2 as a whole. In the determination processing of the option 1, namely, the operation of moving the protection sheet 5 in the X-axis direction is not carried out after the final pressure bonding operations for the whole terminal portion 2 on one side are started and before the final pressure bonding operations are completed, and the operation for the movement in the X-axis direction is carried out in advance before the start of the final pressure bonding operations if the operation of moving the protection sheet 5 in the X-axis direction is to be required after the final pressure bonding operations are started. Commonly, the operation of moving the protection sheet 5 in the X-axis direction (the long feeding operation, in particular) requires longer operation time than the operation of movement in the Y-axis direction. If the operation of movement in the X-axis direction is required, therefore, the operation is carried out before the pressure bonding operations for the whole terminal portion 2 are started, so that the operation of movement in the X-axis direction can be made to overlap with the θ-movement of the panel substrate 1 on occasions when the panel is carried in or out, when the panel is turned for switching to another side of the panel, or the like, for instance. This prevents the operation of moving the protection sheet 5 in the X-axis direction from substantially influencing the tact time for the final pressure bonding operations and attains efficient final pressure bonding processing.

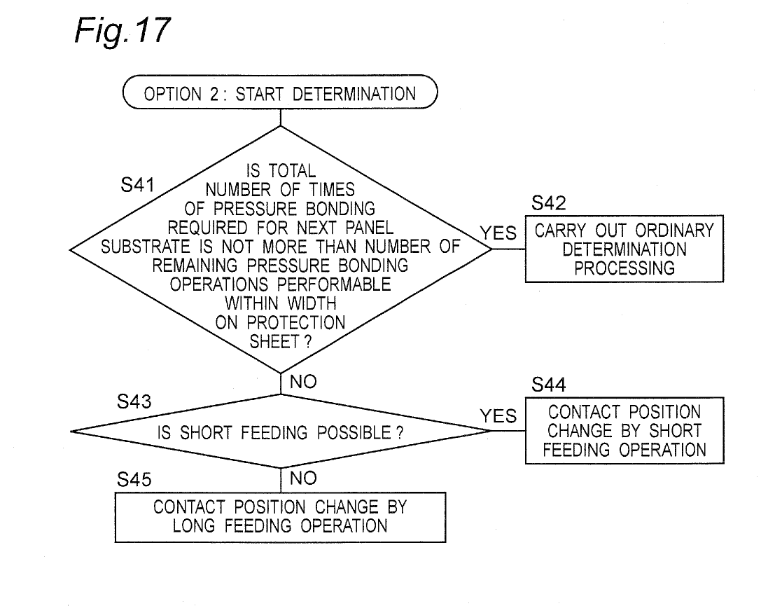

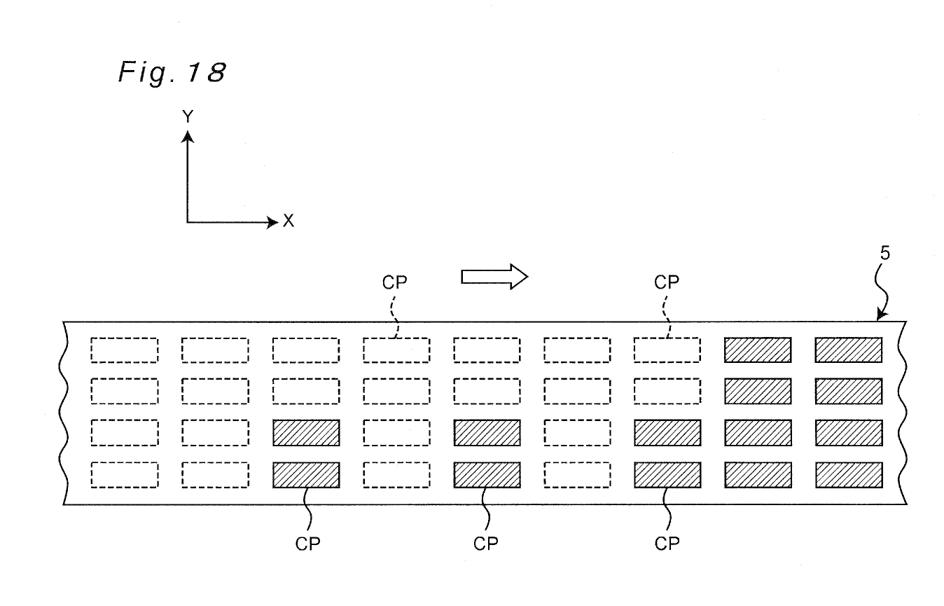

The operation of moving the protection sheet 5 in the X-axis direction is not carried out, according to the determination processing of the option 1 of FIG. 16, while the final pressure bonding operations for the whole terminal portion 2 on one side of the panel substrate 1 are carried out, whereas the operation of moving the protection sheet 5 in the X-axis direction is not carried out, according to determination processing of an option 2 of FIG. 17, while the final pressure bonding operations for the whole terminal portions 2A, 2B and the like of the panel substrate 1 are carried out.

In a step S41 of FIG. 17, specifically, it is initially determined whether a total number of times of pressure bonding required for the final pressure bonding operations to be started for the whole panel substrate 1 (total number of a plurality of pressure bonding operations) is not more than a number of remaining pressure bonding operations that can be performed widthwise on the protection sheet 5. The determination is carried out on basis of a relative positional relation between the pressure bonding heads 31 and the protection sheet 5 in a state in which the positioning between the pressure bonding heads 31 and the pressure bonding positions on the panel substrate 1 has been attained or in a state before performance of the positioning. The positioning is not required to be actually completed, and the determination is carried out by the control device 19 on assumption of such a positional relation for the control and with reference to the information on arrangement of the contact positions that has been stored in the control device 19, or the like.

If it is determined in the step S41 that the total number of times of pressure bonding required for the final pressure bonding operations to be started for the whole panel substrate 1 is not more than the number of remaining pressure bonding operations that can be performed widthwise on the protection sheet 5, the ordinary determination processing shown in FIG. 15 is carried out (step S42).

If it is determined in the step S41 that the total number of times of pressure bonding required for the final pressure bonding operations to be started for the whole panel substrate 1 exceeds the number of remaining pressure bonding operations that can be performed widthwise on the protection sheet 5, it is subsequently determined whether the short feeding operation for the protection sheet 5 is possible or not (step S43). If it is determined that the short feeding operation is possible, the contact position change by the short feeding operation for the protection sheet 5 is performed (step S44). If it is determined in the step S43 that the short feeding operation is impossible, the contact position change by the long feeding operation for the protection sheet 5 is performed (step S45). After that, the final pressure bonding operations for the terminal portion 2 on a first side are performed with use of the pressure bonding heads 31.

When the determination processing of the option 2 is selected and applied, in this manner, the protection sheet 5 can be prevented from being moved in the X-axis direction while the final pressure bonding operations for one panel substrate 1 as a whole are carried out. The movement of the protection sheet 5 in the X-axis direction, if required, is carried out while operations for carrying-in and/or carrying-out of the panel substrate 1 are performed, and thus time required for the movement of the protection sheet 5 in the X-axis direction can be prevented from influencing the tact time for the final pressure bonding operations, so that efficient final pressure bonding processing can be attained.

Though the example in which the pressure bonding units 10 in the final pressure-bonding apparatus 100 or the like are moved independently of one another in the X-axis direction by the driving devices provided individually has been described for the embodiments, a configuration in which the plurality of pressure bonding units 10 are integrally moved by a driving device may be employed instead.

Though the example in which one pressure bonding operation is performed on contact positions of the pressure bonding heads 31 on the protection sheet 5 and in which an operation of change to the next contact positions is thereafter performed has been described for the embodiments, there is no limitation to such an example. A method may alternatively be employed in which one contact position on the protection sheet 5 is used in a final pressure bonding operation a specified number of times that has been set to be a plurality of times and in which an operation of change to the next contact position is thereafter performed, for instance. In this method, information on the number of times of pressure bonding on the same contact position is stored in the storage units of the control device 19, and the operation of change to a contact position is controlled by the control device 19 so that the operation of change to the next contact position is performed after the pressure bonding operation is performed the specified number of times.

Appropriate combinations of arbitrary embodiments out of the various embodiments described above are capable of achieving the effects which the combined embodiments have.

The invention has fully been described with respect to the preferred embodiments in reference to the accompanying drawings; however, various changes and modifications are apparent to those skilled in the art. It is to be understood that such changes and modifications are embraced by the scope of the invention unless departing from the scope of the invention as defined in the appended claims.

The disclosure of specification, drawings, and claims of Japanese patent application No. 2008-253615 filed on Sep. 30, 2008 and the disclosure of specification, drawings, and claims of Japanese patent application No. 2008-253646 filed on Sep. 30, 2008 are incorporated herein by reference in its entirety.

1-17. (canceled)

18. A pressure bonding method of pressure bonding a plurality of objects, arranged with a first interval pitch, onto a pressure bonding area on a first edge portion of a substrate and thereafter pressure bonding a plurality of objects, arranged with a second interval pitch different from the first interval pitch, onto another pressure bonding area on a second edge portion provided so as to be orthogonal to the first edge portion of the substrate, the method comprising:
performing positioning of a plurality of pressure bonding units relative to pressure bonding positions of the objects arranged with the first interval pitch on the first edge portion of the substrate, the pressure bonding units having pressing members including pressing surfaces for pressing the objects against the pressure bonding areas on the substrate and edge portion support members for supporting the edge portions of the substrate on occasion of pressing by the pressing members, the pressure bonding units arranged in a row along a first direction,
pressing and pressure bonding the plurality of objects onto the edge portion of the substrate by the pressing surfaces of the pressing members while protecting the pressing members by a protection sheet in a state in which the protection sheet that has a width at least more than twice a width of the pressing surfaces of the pressing members in a second direction orthogonal to the first direction is placed along the first direction between the pressing members and the edge portion support members,
thereafter performing positioning between pressure bonding positions of the objects arranged with the second interval pitch on the second edge portion of the substrate and the pressure bonding units while turning the substrate along a surface of the substrate so that the second edge portion of the substrate extends along the first direction,
changing contact positions of the pressing members on the protection sheet in the second direction by moving the protection sheet in the second direction at least by a distance not smaller than the width of the pressing surface of the pressing member with turning movement of the substrate, and
thereafter pressing and pressure bonding a plurality of objects onto said another pressure bonding area on the second edge portion through the protection sheet by the pressing surfaces of the pressing members.

19. A pressure bonding method of pressure bonding a plurality of objects onto pressure bonding areas on edge portions of a substrate, the method comprising:
performing positioning of a plurality of pressure bonding units relative to pressure bonding positions of the objects on the edge portions of the substrate, the pressure bonding units comprising pressing members including pressing surfaces for pressing the objects against the pressure bonding areas on the substrate and edge portion support members for supporting the edge portions of the substrate on occasion of pressing by the pressing members, the pressure bonding units arranged in a row along a first direction,
pressing and pressure bonding the objects onto the edge portions of the substrate by the pressing surfaces of the pressing members while protecting the pressing members by a protection sheet in a state in which the protection sheet that has a width at least more than twice a width of the pressing surface of the pressing member in a second direction orthogonal to the first direction is placed along the first direction between the pressing members and the edge portion support members,
performing a second direction changing operation of changing contact positions of the pressing members on the protection sheet in the second direction by moving the protection sheet in the second direction at least by a distance not smaller than the width of the pressing surface of the pressing member for a subsequent pressure bonding operation on a plurality of other pressure bonding positions on the pressure bonding area on the edge portions of the substrate, and
thereafter pressing and pressure bonding a plurality of objects onto the other pressure bonding positions on the pressure bonding area on the edge portions through the protection sheet by the pressing surfaces of the pressing members, wherein
on occasion when a first substrate having undergone the pressure bonding operation for the objects is carried out and when a second substrate that is to undergo the pressure bonding operation for the objects is carried in, a number of times of performance of the second direction changing operation required for completion of the pressure bonding operations on the pressure bonding areas on the edge portions of the second substrate is compared with a remaining number of times that the second direction changing operation can be performed on the protection sheet, wherein the protection sheet is moved along the first direction, if the required number of times exceeds the remaining number of times, for ensuring the remaining number of times not less than the required number of times, and wherein
the pressure bonding operation for the objects is thereafter performed after the second direction changing operation of changing the contact positions of the pressing members on the protection sheet in the second direction is performed for the pressure bonding areas on the edge portions of the second substrate.
